(19) United States
(12) Patent Application Publication
(10) Pub. No.: US 2004/0173556 A1
(43) Pub. Date: Sep. 9, 2004

(54) Vented closures for containers

(76) Inventors: Daniel D. Smolko, Jamul, CA (US); Gregory J. Kevorkian, Temecula, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/453,864

(22) Filed: Jun. 3, 2003

Related U.S. Application Data
(63) Continuation-in-part of application No. 10/162,119, filed on Jun. 3, 2002.
Application No. 10/162,119 is a continuation of application No. 08/933,639, filed on Sep. 19, 1997, now Pat. No. 6,398,048.
(60) Provisional application No. 60/388,609, filed on Jun. 3, 2002.
(60) Provisional application No. 60/404,355, filed on Aug. 16, 2002.
(60) Provisional application No. 60/458,054, filed on Mar. 25, 2003.

(51) Int. Cl. A61J 9/04

(52) U.S. Cl. 215/11.5

(57) ABSTRACT

Disclosed are beverage containers and closures for beverage containers that are vented for the purpose of reducing negative pressure or vacuum that builds up inside the container when a beverage is being consumed therefrom. Also disclosed are closures which provide for chemical treatment of a liquid by a porous treatment matrix when the liquid is dispensed through the closure.

### RELATED APPLICATION DATA

This application claims priority under 35 U.S.C. § 119(e) to U.S. Provisional Application Serial No. 60/388,609, filed Jun. 3, 2002, and is also a continuation-in-part of U.S. patent application Ser. No. 10/162,119, filed Jun. 3, 2002, which is a continuation of U.S. patent application Ser. No. 08/933,639 filed Sep. 19, 1997, now U.S. Pat. No. 6,398,048, the disclosures of which are hereby incorporated by reference in their entireties.

### BACKGROUND OF THE INVENTION

1. Field of the Invention

In one aspect, this invention relates to closures for beverage containers and more particularly to closures that are vented for the purpose of reducing negative pressure or vacuum that builds up inside the container when a beverage is being consumed therefrom. In a related aspect, this invention also relates to a device and method of construction of a beverage container used to cool a liquid by means of pervaporation.

2. Description of the Related Art

A large variety of beverage containers are constructed with a small opening or drinking spout through which the fluid contents can be extracted. The opening is adapted so that a person can place their mouth over the opening thus forming a seal around the opening. Examples of these types of beverage containers include: a soda-pop bottle having a small annular opening; a drinking cup or spill-proof cup having a cover formed with a drinking spout; and, a nipple-equipped baby bottle. As the fluid contents are being consumed from one of these beverage containers, a negative pressure or vacuum builds up within the container making it necessary to interrupt drinking long enough to allow air to enter into the container equalizing the pressure between the outside and inside atmospheres. This interruption causes inconvenience for adult drinkers and makes it difficult for babies to continue feeding. Numerous solutions have been proposed whereby the beverage container is vented to relieve the buildup of negative pressure. As one would expect, most of the solutions are directed to spill-proof cups or baby bottles for feeding infants.

### SUMMARY OF THE INVENTION

In accordance with a preferred embodiment, there is provided a closure for dispensing fluids from a container. The closure comprises a pair of telescopically coupled first and second members cooperatively defining a fluid path, in which the first member is attached to a base or unitary with the base, the base is adapted to be secured, connected or attached to a container and the base and/or the first member include one or more sections of a porous vent material which allows passage of gases and inhibits bulk passage of liquid. In a preferred embodiment, the fluid path is opened to allow fluid flow out of a container by moving the second member relative to the first member, including by twisting or pulling away the second member relative to the first. In some embodiments, the porous vent material is covered by the second member when the closure is in a closed position and exposed to air when the closure is in an open position.

In accordance with a preferred embodiment, there is provided a closure for treating and dispensing a liquid, comprising a base comprising means to secure the closure to a container, a liquid path through the base through which liquid passes when the closure in use a porous treatment matrix contained within or connected to the liquid path, through which liquid passes when the closure is in use, and, optionally, a porous venting matrix secured to the base, wherein said porous venting matrix allows for passage of gases through the porous venting matrix and inhibits passage of liquid through the porous venting matrix thereby allowing for equalization of air pressure between a first location in contact with a first portion of said porous venting matrix and a second location in contact with a second portion of said porous venting matrix. Treatments conferred to a liquid as it passes said through the closure by the treatment matrix include, but are not limited to, selective or non-selective elimination or addition of chemicals, whether by chemical composition, size, or other property; cation and/or anion exchange; and chemical reactions. In a preferred embodiment, the treatment is a chemical treatment comprising selectively removing a preservative or other chemical from the liquid.

In another embodiment, there is provided a closure for dispensing a liquid, comprising a base comprising means to secure the closure to a container, a liquid path through the base through which liquid passes when the closure in use, and a porous flow matrix having a high liquid flux rate and a low water intrusion pressure contained within, attached or connected to the liquid path, through which liquid passes when the closure is in use, wherein the porous flow matrix substantially prevents flow of liquid through the closure when the air pressure on opposing ends of the matrix are substantially equal. In a preferred embodiment, the closure further comprises a porous venting matrix secured to the base.

In another embodiment, there is provided a beverage dispensing assembly, comprising a cap having an opening therein to allow flow of liquid and gas, a base housing adapted to be secured to a container, and a generally hydrophobic porous vent material having a high water intrusion pressure carried by (e.g. contained within, attached to, unitary with, or otherwise connected to) said base housing, wherein the base housing and cap are movably coupled and cooperatively define a liquid path and vented air passing into the container during use follows a central axis around which the liquid flows as it passes out of the container and through the dispenser, thereby reducing air entrainment in the dispensed liquid.

Preferred embodiments of the closures and assemblies disclosed herein may include one or more of the following: a vent material comprising plastic, metal, ceramic and/or glass; hydrophobic vent material; and plastic vent material having a high water intrusion pressure. Additionally in preferred embodiments of closures and assemblies: the porous vent material provides sufficient venting to allow a substantially continuous liquid flux rate from the closure without creating a substantial pressure differential across the closure, preferably at least about 500 ml/min/cm², including at least about 50 ml/min/cm²; the closure provides a pressure drop during dispensing of less than about 2 psi., including less than about 1 psi.

In preferred embodiments, a closure or assembly includes a porous flow matrix within at least a portion of the fluid path, wherein the flow matrix is adapted to substantially inhibit flow of liquid through the flow matrix unless an air pressure differential (preferably about 0.05 to 2.0 psi) exists between inside and outside a container to which the closure is attached. Also, in preferred embodiments, the closure is in combination with a container, wherein the container has a neck with external threads adapted to cooperate with female threads on the base to attach the closure to the container. Alternatively, an assembly or closure has a base adapted to couple with the top of an aluminum beverage can.

### BRIEF DESCRIPTION OF THE DRAWINGS

FIG. 1 is an exploded perspective view of a baby bottle showing the plastic bottle body, the vent, the nipple, and threaded ring in positional relationship to each other.

FIG. 2A shows a cross section of the closed end of the bottle body showing the vent secured to the bottle body by injection molding (see line A, FIG. 1 for plane of section for views 2A-2D and line B, FIG. 1 for cut-off line defining the lower part of bottle in views 2a-2d).

FIG. 2b shows a cross section of the closed end of the bottle body showing the vent secured to the bottle body by welding, sealant or sonic sealing.

FIG. 2c is a cross-sectional side view of the closed end of the bottle body showing the vent formed as a plug and inserted into a hole formed in the bottle body.

FIG. 2d is a cross-sectional side view of the closed end of the bottle body showing the vent formed as a plug with a shoulder and inserted into a cavity formed in the bottom of the bottle body.

FIG. 3 is an exploded perspective view of a sports bottle with a vent shown in positional relationship to the bottom of the bottle.

FIG. 4 is a cross-sectional side view of a screw-on lid for a drinking cup showing a vent secured to the inner surface of the cap by welding, sealant or sonic sealing.

FIG. 5 is a cross-sectional side view of a vented recloseable bottle closure with provisions for venting located in the shoulder and along the fluid path stem. Porous anti-spill matrix is shown in two locations along with an optional straw. An optional protective capsule is shown over the spout as part of the packaging.

FIG. 6 is an illustration of the air flow path through the shoulder vents located within a vented bottle closure of the type in FIG. 5.

FIGS. 7A through 7C depict various geometric arrangements of porous materials within one or more planes.

FIGS. 8A and 8B show a stacked packaging configuration in exploded and side views of one embodiment of a vented bottle closure and method to convert from storage to use mode. This configuration is designed for use with packaging of carbonated beverages.

FIGS. 9A through 9C are exploded and cross-sectional views of a capsule packaging configuration for a vented bottle closure with vents located in shoulder and method to convert from storage to use mode. This configuration may be used with packaging of carbonated beverages.

FIGS. 10A and 10B illustrate cross-sectional views of a vented box-type single cavity beverage container with optional porous anti-spill matrix in fluid path in addition to optional straw and recloseable spout. FIGS. 10C and 10D are cross sections of vented partitioned beverage containers with optional porous anti-spill matrix in fluid path with options of straw and recloseable spout.

FIG. 11 illustrates a cross-sectional view of a vented closure system with a recloseable spout with optional straw in the fluid path for use with beverage cans. The venting path can be closed off when the spout is in the closed position to prevent evaporation of the contents.

FIG. 12A shows a vented closure with porous anti-spill matrix in the fluid path for use with beverage containers adapted to hold hot liquids. FIGS. 12B and 12C show vented closures for single and multi-use food storage containers.

FIGS. 13A through 13D are cross-sectional views of a vented wine bottle closure with optional integral purification matrix within the fluid path and a preferred packaging configuration with conversion from storage to use mode.

FIGS. 14A and 14B show cross-sections of a vented beverage can closure in open and closed configurations with optional porous anti-spill matrix and recloseable spout that can be used with carbonated beverages.

FIGS. 15A through 15D show cross-sections of a vented beverage closure with recloseable spout and porous anti-spill matrix. The venting path can be closed off when the spout is in the closed position to prevent evaporation of the contents.

FIGS. 16A through 16C show cross-sectional views of a recloseable vented wine bottle closure with optional integral porous purification matrix within fluid path and its corresponding packaging configuration.

FIGS. 17A through 17E depict various purification schemes for the removal, exchange, or conversion of unwanted contaminants from liquids using porous materials.

FIGS. 18A through 18C show a flow selective vented valve derived from a combination of porous and non-porous materials.

FIG. 19 shows a multifunctional carbonated beverage closure system for pressure relief, venting, and fluid delivery.

FIGS. 20A and 20B show exploded views of multifunctional beverage closure system cap assembly, fluid, vent, and pressure relief paths.

FIGS. 21A through 21C show multifunctional beverage closure system cap position and engagement for pressure release, venting, and liquid release.

FIGS. 22A through 22D show a vented twist closure design suitable for high volume automated assembly. The closure is designed with integral vent and liquid path shut-offs and is suitable for both carbonated and non-carbonated liquids. The entire closure is assembled using highly automateable press-fit or snap-fit mechanisms. The liquid fluidic path is reversed compared to conventional closures in order to optimize venting attributes and enhance the drinking experience.

FIGS. 23A through 23D show another vented twist closure design suitable for high volume automated assembly. This closure is also designed with integral vent and liquid path shut-offs and is suitable for both carbonated and non-carbonated liquids. This closure contains one component that has the porous venting material either insert molded or welded using conventional equipment and techniques. The closure is assembled using highly automated press-fit or snap-fit mechanisms.

FIGS. 24A through 24C show a large diameter vented closure with recloseable cap suitable for use with sports-type bottles and other reusable containers. The venting air path has been optimized to enhance the drinking experience.

FIGS. 25A through 25C depict another large diameter vented closure suitable for use with sports-type bottles and other container types. The closure contains a self-sealing elastomeric valve for anti-spill control in addition to an optimized venting air path to enhance the drinking experience.

The figures illustrate preferred embodiments and are intended to be merely exemplary and representative of certain embodiments. To that end, several figures contain optional features that need not be included in any particular embodiment of the invention, and the shape, type, or particular configuration of container or closure illustrated should not be taken as limiting on the invention.

### DETAILED DESCRIPTION OF THE PREFERRED EMBODIMENTS

Disclosed herein below are beverage containers and container closures including those that are vented for the purpose of reducing negative pressure or vacuum that builds up inside the container when a beverage is being consumed therefrom. In preferred embodiments, the containers and/or closures comprise porous vent materials.

Porous vent materials may be made of any of a wide variety of materials, including, but not limited to, plastics, metals, glass, and ceramics. Combinations of plastics with metals, glass, or ceramics may also be used. The combinations may be intimate such as from blending of two or more components to become co-sintered, or may be layered such as from multilaminate structures derived from two or more materials. Combinations of different plastics, elastomers, metals, glasses, or ceramics can also be cosintered or fabricated into multilaminate structures for use as porous materials. Preferred plastics for porous vent materials include, but are not limited to thermoplastic polymers, thermoset elastomers, and thermoplastic elastomers. Preferred thermoplastic polymers include, but are not limited to, low density polyethylene (LDPE), linear low density polyethylene (LLDPE), medium density polyethylene (MDPE), high-density polyethylene (HDPE), ultra-high molecular weight polyethylene (UHMWPE), polypropylene (PP) and its copolymers, polymethylpentene (PMP), polybutylene terephthalate (PBT); polyethyleneterephthalate (PET), polyethyleneterephthalate glycol modified (PETG), polyetheretherketone (PEEK), ethylenevinylacetate (EVA), polyethylenevinylalcohol (EVOH), polyacetal, polyacrylonitrile (PAN), poly(acrylonitrile-butadiene-styrene) (ABS), poly(acrylonitrile-styrene-acrylate) (AES), poly(acrylonitrile-ethylene-propylene-styrene) (ASA), polyacrylates, polymethacrylates, polymethylmethacrylate (PMMA), polyvinylchloride (PVC), chlorinatedpolyvinylchloride (CPVC), polyvinyldichloride (PVDC) fluorinated ethylenepropylene (FEP), polyvinylfluoride (PVF), polyvinylidinefluoride (PVDF), polytetrafluoroethylene (PTFE), polyester, cellulosics, polyethylenetetrafluoroethylene (ETFE), polyperfluoroalkoxyethylene (PFA), nylon 6 (N6), polyamide, polyimide, polycarbonate, polyetheretherketone (PEEK), polystyrene (PS), polysulfone, and polyethersulfone (PES). Preferred thermoset elastomers include styrene-butadiene, polybutadiene (BR), ethylene-propylene, acrylonitrile-butadiene (NBR), polyisoprene, polychloroprene, silicone, fluorosilicone, urethanes, hydrogenated nitrile rubber (HNBR), polynorborene (PNR), butyl rubber (IIR) to include chlorobutyl (CIIR) and bromobutyl (BIIR), fluoroelastomers such as Viton® and Kalrez®, Fluorel™, and chlorosulfonated polyethylene. Preferred thermoplastic elastomer (TPE) categories include thermoplastic olefins (TPO) including those commercially available as Dexflex® and Indure®; elastomeric PVC blends and alloys; styrenic block copolymers (SBC) including styrene-butadiene-styrene (SBS), styrene-isoprene-styrene (SIS), styrene-ethylene/butylene-styrene (SEBS), and styrene-ethylene-propylene-styrene (SEPS), some commercially available SBCs include Kraton®, Dynaflex®, and Chronoprene™; thermoplastic vulcanizate (TPV, also known as dynamically vulcanized alloys) including those commercially available as Versalloy®, Santoprene®, and Sarlink®; thermoplastic polyurethane (TPU) including those commercially available as ChronoThane®, Versollan™, and Texrin®; copolyester thermoplastic elastomers (COPE) including those commercially available as Ecdel®; and polyether block copolyamides (COPA) including those commercially available as PEBAX®. Preferred metals for porous materials include stainless steel, aluminum, zinc, copper and its alloys. Preferred glass and ceramics for porous materials include quartz, borosilicate, aluminosilicate, sodiumaluminosilicate, preferably in the form of sintered particles or fibers derived from said materials. The foregoing list of preferred materials is referenced throughout this specification.

A preferred method of making macroporous plastic is by a process called sintering, wherein powdered or granular thermoplastic polymers are subjected to the action of heat and pressure to cause partial agglomeration of the granules and formation of a cohesive macroporous sheet or part. The macroporous material comprises a network of interconnected macropores that form a random tortuous path through the sheet. Typically, the void volume or percent porosity of a macroporous sheet is from 30 to 65% depending on the conditions of sintering although it may be greater or lesser than the stated range depending on the specific method of manufacturer. Due to surface tension, macroporous material can be tailored to repel or absorb liquids, but air and other gases can readily pass through. U.S. Pat. No. 3,051,993 to Goldman, herein incorporated by reference in its entirety, discloses the details of making a macroporous plastic from polyethylene.

Porous plastic, including macroporous plastic, suitable for making a vent in accordance with preferred embodiments, can be manufactured in sheets or molded to specification and is available for purchase from a number of sources. Porex Corporation (Fairburn, Ga., U.S.A.) is one such source, and provides porous plastic under the trademark, POREX®. Porous plastic sold under the name POREX® can be purchased in sheets or molded to specification from any one of the thermoplastic polymers previously described. The average porosity of such POREX® materials can vary from about 1 to 350 microns depending on the size of polymer granules used and the conditions employed during sintering. GenPore (Reading, Pa., U.S.A.) is another manufacturer of porous plastic products, with pore sizes ranging from 5 to 1000 microns. MA Industries Inc. (Peachtree City, Ga., U.S.A.) also manufactures porous plastic products. Porvair Technology Ltd (Wrexham North Wales, U.K.) is another manufacturer of porous products supplying both porous plastic (range of 5 to 200 um pore size under brand name Vyon™) and porous metal media (under brand name Sinterflo®).

The basic size, thickness and porosity of the plastic chosen to make a vent may be determined by calculating the amount of material that must pass through the vent in a given period of time (flow rate). The flow rate for a given area of vent is known as the flux rate. The flow and flux rates of a given macroporous plastic varies depending on factors including the pore size, percent porosity, and cross sectional thickness of the vent and is generally expressed in terms of fluid volume per unit time per unit area for flux rate and volume per unit time for flow rates. To achieve a sufficient degree of venting, the flow rate of the vent is such that the volume of air per minute that passes through the vent equals or exceeds the volume of beverage per minute that is removed from the container by drinking or dispensing. In the case of an infant, a flow rate of about 50 to 200 ml/min of fluid delivery is sufficient to provide a pleasurable drinking experience, whereas for most adults under normal drinking conditions, a flow rate of about 250 to 5000 ml/min of fluid delivery is preferred. In a preferred embodiment, the combination of macroporous vent pore size, percent porosity, and thickness results in venting rates capable of providing on average about 50 to 5000 ml/min fluid or beverage delivery rates out of the container, including about 75, 100, 200, 250, 300, 400, 500, 600, 700, 750, 800, 900, 1000, 1500, 2000, 2500, 3000, 3500, 4000 and 4500 ml/min including about 50 to 200 ml/min for infants, about 100 to 500 ml/min for toddlers, about 250 to 2500 ml/min for children, and about 500 to 5000 ml/min for young and mature adults. In a preferred embodiment, the flux of beverage delivered through a vented closure is about 50 to 5000 ml/min*cm², including about 75, 100, 200, 250, 300, 400, 500, 600, 700, 750, 800, 900, 1000, 1250, 1500, 1750, 2000, 2500, 3000, 3500, 4000 and 4500 ml/min*cm².

In common usage, “Macroporosity” generally refers to the overall void volume of a material or its macrostructure. The term “Macroporous” is generally used to classify a material's individual pores that are considered large in size. The term “Microporosity” generally refers to the individual pore sizes or distribution of pore sizes that constitute the microstructure of a porous material. The term “Microporous” is generally used to classify a material's individual pores that are considered small in size. For purposes of the disclosure herein, pore size (diameter) is classified according to the International Union of Pure and Applied Chemistry (IUPAC) Subcommittee of Macromolecular Terminology, definitions of terms drafted on Feb. 26, 2002. This standard divides pore size classification into three categories: Microporous (<0.002 μm), Mesoporous (0.002 to 0.050 μm) and Macroporous (>0.050 μm). Also for the purposes of this disclosure herein, void volume will be discussed in terms of the “Percent Porosity” of the material.

Preferred porous materials include those in which the pores on opposite surfaces (what will become the interior and exterior surfaces) are interconnected such that the two sides are in communication with each other. Such interconnections are preferably not, however, straight through as to create a tubes or ports through which material passes; instead a network of pores creates a tortuous path for the liquid or gas to pass.

For a single layer vent, the porous materials are preferably macroporous with pore sizes greater than or equal to 0.05 μm, preferably about 0.1 to 500 μm, and about 0.5 to 10 μm, including 0.25, 0.5, 1, 5, 15, 20, 40, 60, 80, 100, 150, 200, 250, 300, 350, 400, and 450 μm. In one embodiment, the vent materials used in conjunction have pore sizes between 0.1 and 100 μm, preferably between 0.5 and 75 μm. The percent porosity (percent open area) of the materials are preferably about 10 to 90%, including 30 to 75% or 50 to 70%, including 20%, 40%, 60%, and 80%. Preferred thicknesses of the porous materials include from 0.025 to 7 mm, including between 1 and 3 mm. Preferred thickness for vent materials include about 0.05 to 5 mm and about 0.1 to 3.0 mm, including 0.2, 0.3, 0.5, 0.7, 1.0, 1.25, 1.5, 1.75, 2.0, and 2.5 mm. Other embodiments may have values for the above parameters that are above or below those set forth above. For the values set forth in this paragraph, as well as elsewhere in the specification, the stated ranges include as the values contained in between the values specifically mentioned. In other embodiments, materials can have one or more properties having values lying outside the disclosed ranges.

The vent material can be derived from plastic, elastomers, glass, metal, or combinations thereof. Some preferred matrix materials, including thermoplastic polymers, thermoset elastomers, thermoplastic elastomer, metals, glass and ceramics are as detailed above. Vent materials may be purchased from commercial sources, or they may be made according to a variety of techniques. U.S. Pat. No. 4,076,656 to White et al. details one technique in which porogens are added to molten or dissolved materials, which can be leached out with a solvent, or extracted with supercritical fluids after the material sets and is in its final form. U.S. Pat. No. 5,262,444 to Rusincovitch et al. details another technique to create porous material by introducing porogens that evolve into gases after processing a material, to leave behind a porous structure. These patents are hereby incorporated by reference in their entireties.

Single layer porous vent material is advantageously used to provide venting for hot liquid and food container closures such as those used for carry-out applications. These may include containers for hot liquids such as coffee, tea, chocolate, soups, gravies, and sauces. Low cost porous vent materials with low to medium air flux rates and high water intrusion pressures are well suited for this type of application. The porous vent material preferably does not substantially detract from the structural integrity of the closure. In another embodiment, porous venting materials with similar characteristics to the above mentioned materials are advantageously selected to provide venting for plasticware type food storage containers that may be disposable or reusable depending on the desired usage. The vented food containers are also suited for microwave heating environments, in which they will allow the food container to safely vent steam during the heating process. In microwavable embodiments, preferred porous materials are made from plastics including elastomers, as metal would be disadvantageous for microwave heating or reheating. Preferred plastics include high-density polyethylene (HDPE), ultra-high molecular weight polyethylene (UHMWPE), polypropylene (PP), polymethylpentene (PMP), polyetheretherketone (PEEK), poly(acrylonitrile-butadiene-styrene) (ABS) polyesters, polyvinyldichloride (PVDC) polyvinylfluoride (PVF), polyvinylidinefluoride (PVDF), polytetrafluoroethylene (PTFE), polyamides, polyethylenetetrafluoroethylene (ETFE), polyperfluoroalkoxyethylene (PFA), polyimide, polycarbonate. Preferred elastomers are of the thermoset type and include styrene-butadiene, polybutadiene (BR), ethylene-propylene, acrylonitrile-butadiene (NBR), polyisoprene, polychloroprene, silicone, fluorosilicone, urethanes, hydrogenated nitrile rubber (HNBR), polynorborene (PNR), butyl rubber (IIR) to include chlorobutyl (CIIR) and bromobutyl (BIIR), as well as other plastics referenced above.

The basic size, thickness and porosity of the plastic chosen to make a vent may be determined by calculating the amount of air that must pass through the vent in a given period of time (flow rate). The flow rate of a given macroporous plastic varies depending on factors including the pore size, percent porosity, and cross sectional thickness of the vent and is generally expressed in terms of fluid volume per unit time. To achieve a sufficient degree of venting, the flow rate of the vent should be such that the volume of air per minute that passes through the vent in or out of the container is sufficient to maintain the atmospheric pressure inside of the container in balance with the outside container pressure. In addition, to achieve a sufficient degree of venting during consumption from a hot beverage container, the flow rate of the vent should be such that the volume of ambient air per minute that passes through the vent into the container is sufficient to replace the volume of liquid consumed during the immediate time frame. Preferred flow rates are disclosed above and include about 10 to 3500 ml/min or about 500 to 2500 ml/min for venting of steam, between about 10 to 100 ml/min for hot liquids to vent steam outside of the container, and about 50 to 1000 ml/min including about 100 to 500 ml/min for venting of air into hot beverage containers to aid consumption of the beverage. It should be noted that because of the interrelatedness of the concepts of flow rates and flux rates (a flux rate being a flow rate per unit area), these terms may be used somewhat interchangeably when referring to desired properties of a matrix material.

For laminated hydrophobic vent materials, the resultant properties of the final vent material will depend at least in part on the unique characteristics of each laminate that comprises the laminate. For example, a thin material with poor structural integrity, high water intrusion pressure, and high flux rate can be laminated to a thicker material with good structural integrity, low water intrusion pressure, and high flux rate to produce a vent material with high water intrusion pressure, high flux rate, and good structural integrity. In such an embodiment, preferred thin laminants have high water intrusion pressure and high flux rates, and are preferably derived from plastic, elastomers, metals, or ceramic materials including the specific materials mentioned hereinabove. Thin layers preferably range between about 20 μm and 1000 μm with average pore size preferably between about 0.5 and 350 μm, including between about 5 and 150 μm, and the percent porosity is preferably about 10 to 90%, including about 30 to 75%, and about 50 to 70%. The foregoing ranges are those used in connection with certain preferred embodiments. Use of materials having values outside the stated ranges if desirable for a particular application is contemplated.

The thin layers can be laminated to thicker layers using techniques familiar to those in the art. Thick laminants are preferably derived from plastic, elastomers, metals, or ceramic materials, including but not limited to the listing of preferred materials listed supra. Thickness preferably ranges from about 100 to 5000 μm with average pore sizes preferably ranging from about 0.5 to 500 μm. The percent porosity of the thick layer materials can range from about 10 to 90%, including between 30 to 75%, and between 50 to 70%.

Vent material may also be derived from porous materials made from blends. In a preferred embodiment, the porous materials comprise a fluorinated resin, including, but not limited to, polyvinylfluoride (PVF), polyvinylidinefluoride (PVDF), polytetrafluoroethylene (PTFE), polyethylenetetrafluoroethylene (ETFE), fluorinated ethylene propylene (FEP), polyperfluoroalkoxyethylene (PFA), and/or fluorinated additives such as Zonyl®, blended with one or more selected polyolefin or other resins, including those selected from the series of polyethylenes (LLDPE, LDPE, MDPE, HDPE, UHMWPE) polypropylene, polyesters, polycarbonates, ABS, acrylics, styrene polymethylpentene (PMP), polybutylene terephthalate (PBT); polyethyleneterephthalate (PET), polyetheretherketone (PEEK), ethylenevinylacetate (EVA), polyacetal, poly(acrylonitrile-butadiene-styrene) (ABS), poly(acrylonitrile-styrene-acrylate) (AES), poly(acrylonitrile-ethylene-propylene-styrene) (ASA), polyesters, polyacrylates, polymethacrylates polymethylmethacrylate (PMMA), polyvinylchloride (PVC), polyvinyldichloride (PVDC) nylon 6 (N6), polyamide, polyimide, polycarbonate, polystyrene, and polyethersulfone (PES). The resulting blends, including sintered blends, have porous structures with varying amounts of porosity, flexibility and mechanical strength determined predominately from the non-PTFE or other non-fluorinated resin, and high water intrusion pressures determined predominately from the fluorinated resin due to its preferential migration to the pore surface during the sintering process. The percent porosity, pore size, and thickness are preferably as noted above. Blended matrix materials may be purchased from commercial sources, or they may be made according to a variety of techniques. U.S. Pat. No. 5,693,273 to Wolbrom details a process of cosintering to produce multi-porosity porous plastic sheets that can be derived from two or more polymeric resin materials and U.S. Pat. No. 5,804,074 to Takiguchi et al. et al. details a process to produce a plastic filter by cosintering two or more polymeric resins in a molding process to produce filter parts. Both of these patents are hereby incorporated by reference into this disclosure in their entirety.

Some porous materials are permeable to liquids. The rate of permeability is related to its liquid flux rate. The liquid flux rate is determined by factors including the pore size, percent porosity, surface tension, and cross sectional thickness. A favorable combination of these factors produces liquid flux rates capable of delivering beverage liquids from a container at suitable flow rates, including those described hereinabove which have been found provide a pleasurable drinking experience.

Porous materials can be constructed or engineered to be hydrophilic. Commodity plastic materials such as nylon, polysulfone, and the cellulosics, are available in hydrophilic grades. These hydrophilic materials can be milled into particles and sintered using techniques known to those familiar in the art to produce hydrophilic porous materials with high liquid flux rates. Porous hydrophilic plastic, including macroporous plastic, suitable for liquid beverage delivery in accordance with preferred embodiments, can be manufactured in sheets or molded to specification and is available for purchase from a number of sources. Porex Corporation (Fairburn, Ga., U.S.A.) is one such source, and provides hydrophilic porous plastic under the trademark, POREX®. Porous plastic sold under the name POREX® can be purchased in sheets or molded to specification from any one of the thermoplastic polymers previously described. The average porosity of such materials can vary from about 1 to 350 microns depending on the size of polymer granules used and the conditions employed during sintering. GenPore (Reading, Pa., U.S.A.) is another manufacturer of hydrophilic porous plastic products, with pore sizes ranging from 5 to 1000 microns. MA Industries Inc. (Peachtree City, Ga., U.S.A.) also manufactures hydrophilic porous plastic products. Porvair Technology Ltd (Wrexham North Wales, U.K.) is another manufacturer of hydrophilic porous products supplying both porous plastic (range of 5 to 200 um pore size under brand name Vyon™) and porous metal media (under brand name Sinterflo®). Porous hydrophilic fiber materials preferably range in pore size from 20 to 120 μm with percent porosity ranging from 25 to 80 for the pore volume. Moreover, hydrophobic porous materials, including many of those referenced hereinabove, can be rendered hydrophilic by one or more treatment processes familiar to those skilled in the art including, but not limited to, plasma etching, chemical etching, impregnation with wetting agents, or application of hydrophilic coatings. In addition, a masking process can be used in conjunction with one or more treatment processes to selectively pattern a hydrophobic porous material with regions of hydrophilicity with high liquid flux rates. The patterned materials can advantageously be incorporated into beverage container closures to provide additional control over regulating the flow of fluid from inside to outside the container during consumption. In one embodiment, the patterned porous material is used to provide a rotatable flow selector integral to the beverage closure. Techniques used to render hydrophilic materials more hydrophobic may also be used to render hydrophobic materials more hydrophilic.

A porous vent can be fabricated for assembly into a beverage closure or container, for example, by die cutting or stamping out a disc or ring-shaped geometry from a sheet of macroporous material. The porous vent may also be sinter molded with a suitable process and mold design to yield the final vent geometry in one process. The sinter molding process produces less waste than stamping from sheets, and can be economical depending on the number of parts and tooling costs. Other porous part geometries can be similarly and readily produced with these two techniques, as well as other suitable techniques as may be known or apparent to those skilled in the art to yield components suitable for container closures and containers.

In preferred embodiments, the containers and container closures described herein deliver generally aqueous liquids having surface tensions of approximately 40-75 mN/m, or the range of surface tensions found in most beverages. Although preferred embodiments described herein relate to delivery of beverages, the concepts and closures described herein may be used in the delivery of any fluid.

In the context of this specification, “vent matrix”, “vent material” and similar terms refer to porous materials which allow for easy passage of air while generally avoiding passage of bulk liquid and thus provide venting capabilities. In a vent matrix used with an aqueous liquid, the air flux rate of the vent matrix is high, the water or liquid flux rate is low, and it has a high water intrusion pressure. The term “flow matrix” is similarly used to refer to porous materials which allow for passage of fluid, preferably in the presence of a pressure drop, so as to dispense a liquid. For a flow matrix dispensing an aqueous liquid, the liquid flux rate is preferably high and the water intrusion pressure is preferably low. The higher the liquid flux rate and the lower the water intrusion pressure, the faster the rate at which the liquid will be dispensed. A high flux rate material allows for passage, at a reasonable rate (e.g. a rate which allows for acceptable intended functioning of the closure or container), of gas or liquid (for vent matrix and flow matrix, respectively) through the material. Similarly, a low flux rate material resists or substantially inhibits passage of the liquid (low liquid flux rate) or gas (low gas flux rate). When the liquid is water or aqueous, materials having a low liquid flux rate are also described as having a high water intrusion pressure and materials having a high liquid flux rate are described as having a low water intrusion pressure.

Another important concept is that of pressure drop. Pressure drop is used herein in reference to the absolute value of the difference in pressure between opposite sides of a matrix during venting or dispensing. In one embodiment, discussed in further detail below, pressure drop is used to refer to the pressure difference across the matrix required to initiate flow of liquid through a flow matrix, the flow matrix serving as a non-mechanical check valve.

Vented Containers

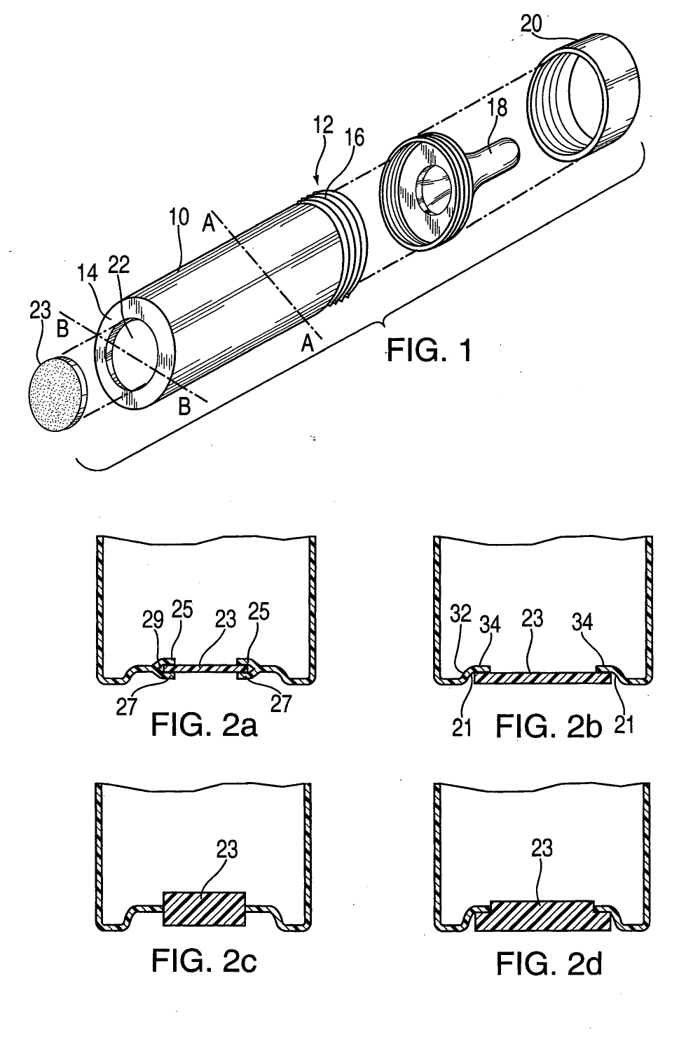

As shown in FIG. 1, one preferred embodiment of vented container is depicted in the form of a baby bottle. The baby bottle comprises an elongated cylindrical bottle 10 having an open end 12 and a partially closed end 14. In one embodiment, the bottle body is preferably formed from a thermoplastic polymer, including, but not limited to, polypropylene, polyethylene or polycarbonate by processes known in the art such as blowmolding or injection molding. The bottle body is formed with a threaded lip 16 at its open end 12 so that an elastomeric nipple 18 can be clamped against the top of the bottle by a threaded ring 20 that is screwed onto the threaded lip 16 of the bottle. The partially closed end 14 of the bottle body is formed with a hole 22 for receiving a vent 23. The vent 23 is made from macroporous plastic and is preferably secured in the hole by one of the methods discussed below.

Once the macroporous vent is obtained, the vent can be secured to the plastic bottle body by any one of a number of methods. In one embodiment, the vent is molded into a cavity that is formed in a wall of the bottle as the bottle is being injection molded (i.e. insert molded). With reference to FIG. 2a, an example is shown wherein the hole-forming detail molded into the bottle wall comprises an inner and outer lip 25 and 27 defining a circular cavity 29 having an inside dimension that corresponds to the outside dimension of the vent 23. Prior to injection molding, the vent 23 would be positioned in the injection mold such that when molten plastic is injected into the mold, the lip detail will form in the bottle wall around the edges of the vent such that a leak-proof seal is created between the bottle wall and the vent with the vent being permanently secured in place.

In a second embodiment, the bottle body is blow molded or injection molded with a hole. In one embodiment, the hole-forming detail in the bottle wall comprises a circular depression 21 as shown in FIG. 2b. A vent disc 23, dimensioned to fit snugly against the sides 32 and bottom 34 of the depression 21, is secured in place using means such as ultrasonic sealing or welding as are known in the art. In the case of welding, the edges of the vent and bottle wall that are to be welded together are subjected to a heat source until melted, and then the edges are butted together and clamped in place until cool. Low temperature heating suitable for welding is preferably accomplished using one of the following: plastics hot-air gun, hot-air blower, infrared heat lamp, radiant tube, wire, or ribbon; or spin-welding techniques.

During any welding, heating or molding process, one should preferably limit the application of heat to the edges of the vent so that the porous characteristics of the vent are not substantially altered anywhere except at the edges of the vent.

The vent can also be secured in place using a sealant or adhesive. The type of sealant used depends on the ability of the sealant to bond with or penetrate the pores of the plastic. One example uses PVC and/or ABS cement to mechanically bond PP to PVC, styrene or ABS. In certain applications, two-part epoxy systems or silicone may be used to secure the vent in place. One consideration is that the adhesive be chemically compatible with the vent material and the other material(s) being bonded.

With reference to FIG. 2c and FIG. 2d, the vent can also be formed as a plug 23 that can be inserted into a hole 22 formed in the wall of the bottle during blow molding or injection molding of the bottle body. In one embodiment, the plug is formed from PTFE and the plug 23 has an outside diameter slightly larger than diameter of the hole 22. In order to insert the plug into the hole, the plug is subjected to low temperature, such as by exposing the plug to liquid nitrogen. The cold temperature causes the plug to shrink enough that the plug can be inserted in the hole. Upon warming, the plug expands to its original size, thus plugging the hole and forming a water-tight seal between the bottle wall and the plug. The plug could also be press fit into the bottle.

One may also use one of the methods described above to secure the vent to a threaded, plastic screw cap similar to the threaded ring 20 used to clamp the nipple onto the open end of the bottle. In this case, the bottle would comprise an elongated tube threaded at each end. The nipple could be clamped to one end of the bottle using the threaded ring and a threaded screw cap provided with a macroporous vent could be threaded on the other end of the bottle body. In a related embodiment, a snap-fit cap may be used in place of the screw cap to secure the vent.

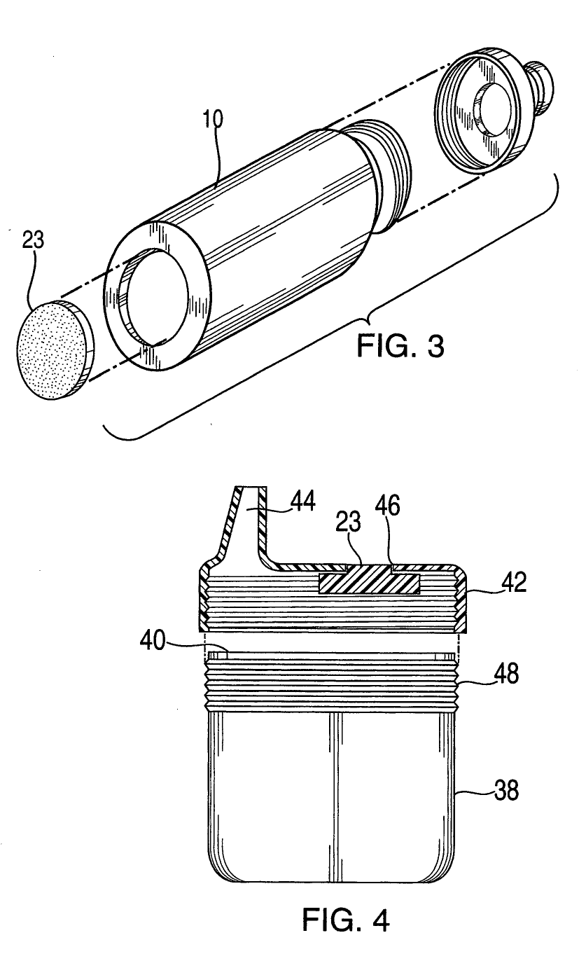

The same methods used to secure the vent to a baby bottle body may also be used to secure the vent to the plastic bodies of other kinds of beverage bottles or containers. As before, the bottle or container is preferably formed from plastic by processes such as blowmolding or injection molding. Examples of these types of bottles or containers include soda-pop bottles, water bottles, sports bottles and canteens. With reference to FIG. 3, a water bottle 36 is shown with a vent 23 secured in the base.

It is also possible to use one of the methods described above to secure the vent to a plastic cover for a drinking cup. With reference to FIG. 4, a drinking cup 38 is threaded at its open end 40. A plastic cover 42 is formed with a rigid drinking spout 44 to one side, a hole forming detail 46 to the other side, and threads 48 for clamping the cover to the cup. The vent 23 is secured in the hole 46 using one of the above-described securing methods. Both the cup and the cover are preferably formed from plastic by processes known in the art such as blowmolding or injection molding.

The previously discussed methods used to secure a vent to a plastic bottle body can also be used to secure a vent to a glass or metal container. For example, the bottle can be molded with a hole-forming detail as previously described and the plastic vent secured therein using sealant or the cold-shrink method. An embodiment in which the vent is secured using a screw cap or snap-cap may also be used with glass or metal containers.

In an alternative embodiment, the vent may be formed from metal or glass by sintering powdered glass or metal under selected conditions of heat and pressure causing partial agglomeration of the granules and formation of a cohesive macroporous substrate. Depending on the conditions chosen, an average porosity of 7 to 350 microns and a void volume of 30 to 65% can be achieved. The glass or metal is preferably rendered hydrophobic either prior to the molding process or subsequent to the molding process using surface modification agents such as organosilanes so as to reduce unwanted leakage of generally aqueous contents. The size, thickness and porosity of a vent may be determined as previously described by calculating the flux rate or flow rate. The sintering conditions and mold dimensions can then be conformed to yield a vent having the desired properties. The glass or metal vent can be secured to a glass, metal, or plastic container using the methods discussed above.

Several embodiments described herein and those illustrated herein utilize a disk-shaped vent. While a disc shape may be preferred for ease of manufacturing and functional efficiency, it is possible to use vents of different shapes and geometries, e.g., oval or rectangular and any such alternate shape is presently contemplated. Preferably the shape of the vent does not prevent the vent from being secured in a leak-proof manner such as by using one of the securing methods disclosed above or equivalent methods.

Although the examples described with reference to FIG. 2 locate the vent in the closed end of the bottle, the vent or multiple vents can just as easily be located along the sidewall of the bottle, and such embodiments are contemplated. The venting material is preferably constructed from hydrophobic macroporous materials, that negate the requirement of moving parts to control venting. The vented closure may be secured to any type of beverage container including plastic, glass bottle, and cans. In the disclosure herein, any of a variety of means and methods may be used to secure or attach a closure to a container. Such means and methods include fittings which are threaded, press fit, snap fit, interference fit, and/or compression fit; adhesives applied to one or more surfaces of the container or closure; welding, including ultrasonic welding; and/or other closure means and methods known in the art. The term “secured” as used herein in reference to the connecting or attachment of a closure to a container, is a broad term, used in its ordinary sense, and includes removable, non-removable (i.e. cannot be removed without disrupting the structure of the closure and/or container), and unitary (e.g. a single, monolithic piece, or the functional equivalent thereof) modes. The term “containers” as used herein is a broad term, used in its ordinary sense, and includes bottles, cans, canteens, jars, and other vessels suitable for holding and/or dispensing liquids. Containers may be made of any suitable material. Also the terms “connected to” and “attached to” are broad terms, used in their ordinary senses, to describe the relationship between two or more parts, include where the parts are removably attached, non-removably attached, adhered such as by adhesives, unitary construction of the two parts, attachment by threaded or press-fit connections, insert molded together, and the like.

In several additional embodiments, hydrophilic and/or hydrophobic porous materials are selected to provide a matrix capable of simultaneous venting and fluid control during beverage consumption. Hydrophobic porous materials can be selectively treated, such as by plasma, chemical etching, coatings, and the likes to yield discrete hydrophilic regions where fluid flow will be permitted to occur. Similarly, this effect can also be realized by joining or placing hydrophilic and hydrophobic materials in close proximity in a manner as to permit selective fluid flow in some regions while providing only venting action in the other regions. Furthermore, regions of fluid flow can be further tailored so as to provide a minimum liquid intrusion pressure to commence liquid flow during consumption (i.e. a non-mechanical check valve). In this way, anti-spill or anti-leak characteristics can be incorporated into the overall functioning of the closure. The tailoring is accomplished by the use of porous materials having desired properties, or by selective treatment as noted above.

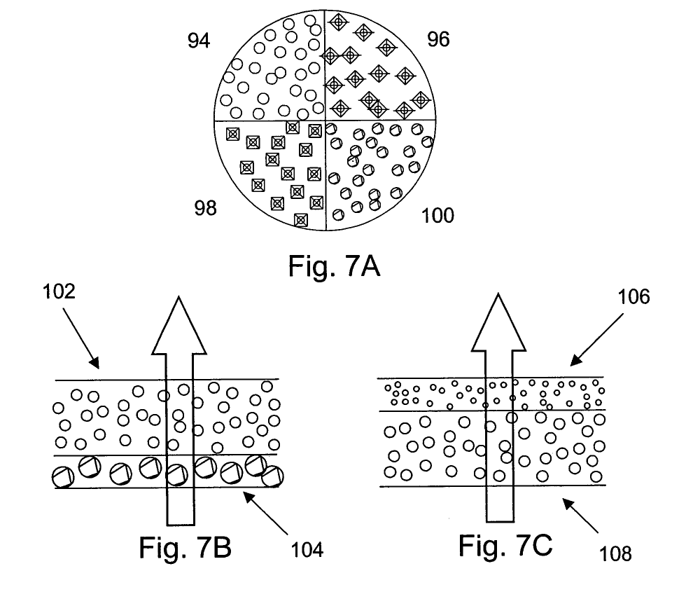

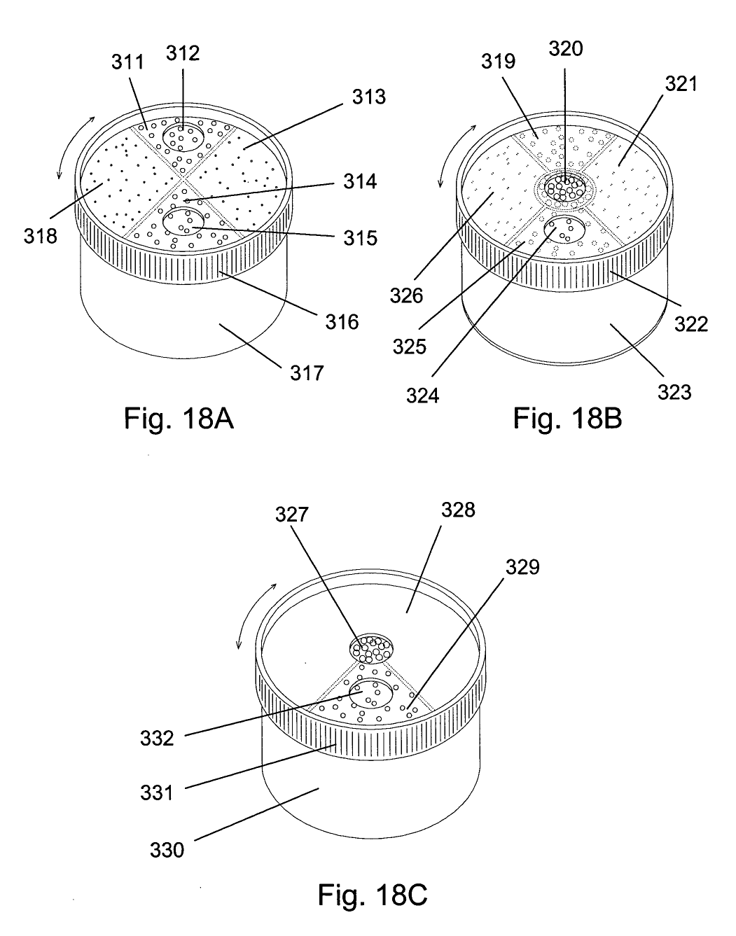

FIGS. 7A-7C depict various preferred arrangements of porosity in one or more planes. Porous matrix combinations are used to obtain properties that are generally not possible with single materials. FIG. 7A shows a single layer of porous material that has been patterned to yield regions of discrete porous properties. The patterning is produced as such by using a suitable masking technique followed by chemical, plasma, or coating treatments. Regions 94-100 are made to differ in hydrophilicity, which alters the materials' flux rates and corresponding water intrusion pressures. The construction of vented closures using this feature is advantageous in providing improved fluidic control during consumption as exemplified in FIGS. 18A-18C.

FIGS. 18A through 18C illustrate three preferred embodiments of fluidic control inserts of the type that can be advantageously positioned within a fluid path to provide container closure functionality. FIG. 18A shows porous regions (311) and (314) with openings (312) and (315) contained within the regions of low water intrusion pressure. Porous regions (313) and (318) have high water intrusion pressures and can stop fluid flow. A rotation by turning ring (316) supported by collar (317) is used to selectively align the openings to allow fluid flow to commence or cease with venting. FIG. 18B differs slightly in that a hydrophobic porous vent matrix is provided within the construction at the center for continuous venting. Porous regions with low water intrusion pressures are located at positions (319) and (325), and has one opening shown in (324). Regions (321) and (326) contain porous regions of higher water intrusion than regions (319) and (325) to provide either slower fluid flow or anti-spill characteristics. Rotation with ring (322) about collar (323) is used to select desired fluid control properties. FIG. 18C differs from the previous two in that region (328) is made to be non-porous. It contains a centrally located continuous venting region (327), with one region of low water intrusion pressure (329) and one opening (332). A rotatable ring (331) is provided that moves about the collar (330).

FIGS. 7B and 7C depict examples of 2-ply laminate constructions of porous matrix materials according to preferred embodiments. In FIG. 7B, a thin layer of relatively hydrophobic porous material (104) has been laminated to a thicker layer of porous material (102) to provide a single matrix with properties derived from both (102) and (104). The direction of flow is shown by the arrow, and the flow is from the thin layer through the thick layer. The construction shown in FIG. 7B is advantageous for constructing porous hydrophobic vents for container enclosures, where high water intrusion pressures and high air flux rates are needed. In FIG. 7C, a thin porous layer of material (106) is shown laminated to a thick porous layer of material (108) with resulting flow properties indicated by arrow, which shows flow from the thicker material through the thinner. The construction shown in FIG. 7C is advantageous for constructing porous flow control matrixes where high liquid flux rates and low water intrusion pressures are needed.

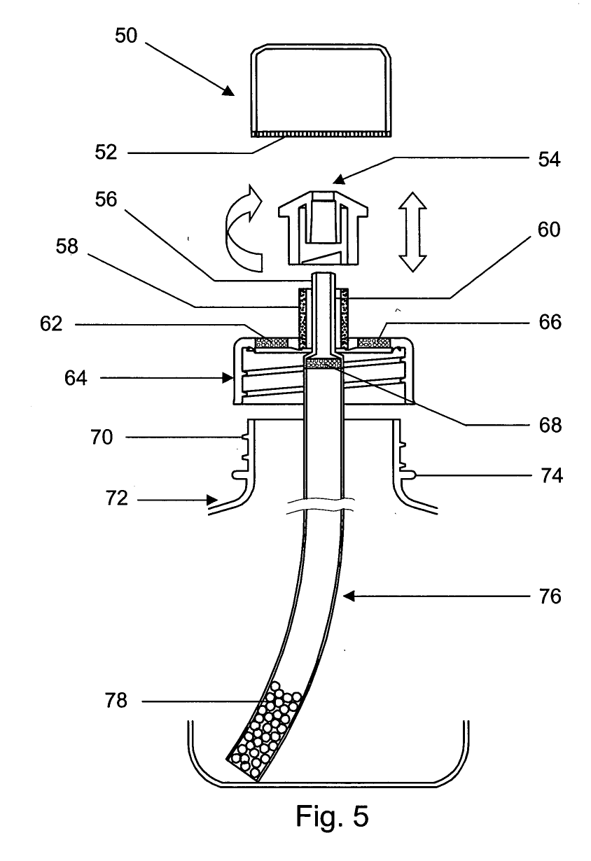

In the embodiment illustrated in FIG. 5, the closure is generally circular, and is preferably threaded for common types of container openings. A generally leak-proof seal is made between the rim of the container opening and the inside of the closure when secured. The seal integrity can be enhanced by the use of elastomeric seals, o-rings, and the like to prevent leakage of carbonated beverages. The container opening can vary in size. For beverages, suitable container opening sizes include round openings having a diameter of about 15 to 80 mm, including about 20, 30, 40, 50, 60, and 70 mm. The container may be made from any suitable material, including plastic, elastomer, metal or glass, but is preferably plastic. FIG. 5 depicts a preferred vented closure system for attachment to a container.

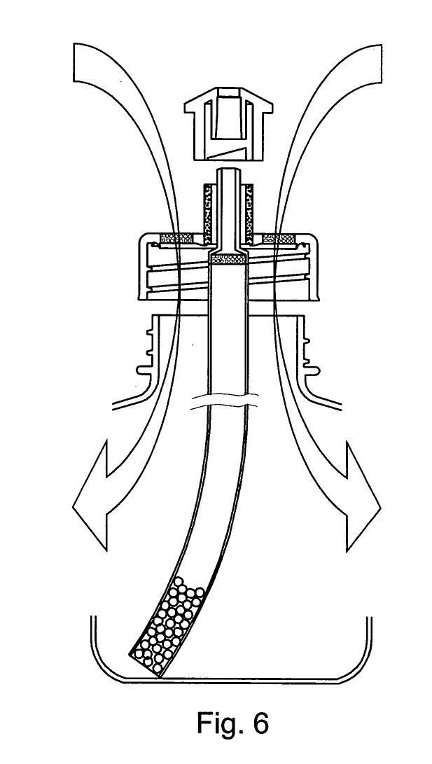

In FIG. 5, a recloseable drinking spout (54) is shown having a telescopic spout, that is a spout that can be manually opened or closed by rotational or linear motion of the spout, resulting in its raising or lowering along the axis of the fluid delivery path. The fluid exits through the spout's opening when the container is inverted or otherwise angled to allow for consumption of the contents. The spout can terminate into one or more openings for the fluid delivery path. Push-pull or rotational movement closing the spout engages the tip of the fluid path (56) to occlude liquid entry out of the spout opening. The spout is sealed such as by compressive forces or by an interference fit between the apex of the fluid path and the spout opening. The seal integrity can be enhanced by the use of elastomeric seals, o-rings, and the like to prevent leakage of carbonated beverages. Porous vent material can be located radially (62) (66) and/or along the circumference (58) of the fluid path (60). The vent materials preferably have relatively high water intrusion pressures and relatively high air flux rates to accommodate a wide range of drinking styles and beverage types. The influx of vacuum eliminating air is diagramed in FIG. 6, shown passing through the porous hydrophobic vents. The venting materials inhibit or substantially prevent the passage of liquid to outside of the container during normal beverage consumption, storage, or accidental tipping of the container. It is understood that some quantity of the molecules in a liquid may pass through the many preferred venting materials. However, as used herein in the context of materials being used as vents, substantially preventing or inhibiting passage of liquid is to be viewed in a functional context in that there is no bulk passage of liquid through the venting material so as to form drops or droplets of liquid that have passed through the venting material. The fluid path can be in any location, but is frequently centered within the base of the closure. The closure (64) is mechanically secured to a bottle (72) by means of complimentary closure threads to the bottle opening (70), although in alternative embodiments, other suitable means of attachment may be used. Optionally, a porous flow control matrix (68) is positioned proximally to the fluid path (60) to provide anti-spill features to the closure. The porous flow control matrix is composed of hydrophobic porous materials with generally low water intrusion pressures and high liquid flux rates, and are strategically positioned within the fluid path, which optionally can include a straw (76), thereby allowing the passage of fluid once a specified pressure drop has been achieved during consumption. The low water intrusion pressure-type hydrophobic porous materials act as “check valves” requiring a minimal pressure drop before fluid flow commences thereby allowing beverage fluid to pass during consumption. The porous “check valves” may be advantageously combined with hydrophobic porous venting materials within the same closure. The flow control matrix functions in similar fashion to a mechanical check valve. In conjunction with the porous vents (62) (66), fluid flow out of the spout is initiated in response to a minimal pressure drop developed during consumption that is usually preceded by an action to invert or angle the container to place it in a comfortable position for consumption and also to allow the fluid to press up against the flow control matrix. The flow of fluid remains substantially uninterrupted due to vacuum elimination caused by the action of the porous vents. When consumption is halted, the container is leveled, the pressure drop is removed, and fluid ceases to flow. FIG. 5 depicts one way in which the preferred closure is optionally packaged for cleanliness. In the illustrated embodiment, a protective capsule (50) is used to guard the closure. The illustrated embodiment may be further functionalized with an optional straw (76) as provided, and joined to the closure at the proximal end of the fluid path. The straw may contain the optional porous fluid control device at the distal (78) position of the straw. The fluid control matrix may also be located at the proximal end of the fluid path (68) in combination with the straw. The optional straw beverage closure systems represented in FIG. 5 are preferably used in a substantially upright position.

Anti-Spill Vented Beverage Container/Closure & Dispensing System for Straw Boxes

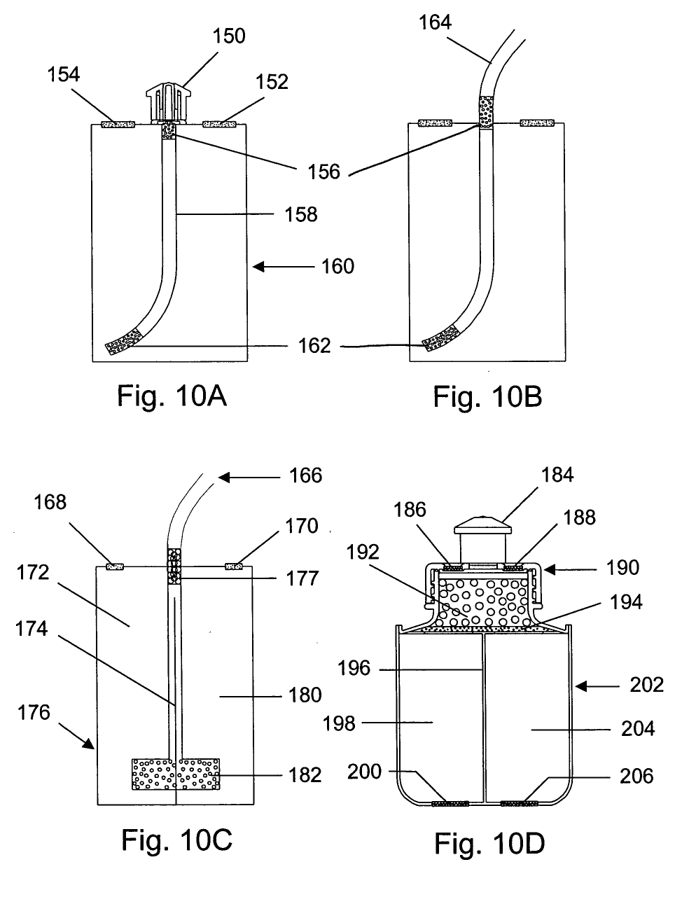

FIGS. 10A through 10B depict configurations of two preferred embodiments of straw boxes. In FIG. 10A, a straw (158) is provided forming the fluid path of the container with provisions for porous venting material (152) (154) in the body or top of the container box. In one embodiment, a recloseable drinking spout (150) is provided. The single box cavity optionally contains a porous flow control matrix (156) with low to moderate water intrusion pressure joined to the proximal (156) and/or distal (162) portion of the straw. The porous matrix (156, 162) provides anti-spill properties to the beverage box system (160). FIG. 10B depicts an embodiment with a dispensing straw (164) having optional porous flow matrix (156, 162), used in lieu of a recloseable drinking spout.

Vented and Partitioned Multi-Component Beverage Closure/Container Systems

Porous materials can be advantageously incorporated into beverage containers to provide a novel mixing system for multi-component beverages. Typically these beverage containers are constructed from partitioned or multi-cavity bodies containing two or more separate fluid compartments. This novel mixing system is particularly well suited for multicomponent beverage components capable of spontaneous carbonation when mixed. In one embodiment, a hydrophobic porous material with low water intrusion pressure and high liquid flux rate is layered to a thicker region of hydrophilic porous material with high liquid flux rate. The beverage container cavities and partitions are sealed at the top by the porous laminant material. Additional hydrophobic vent material may also be provided preferably in the beverage closure body to provide vacuum elimination during consumption that also affords uniformly mixed liquid components exiting from the random and tortuous porous path of interconnected pores into the spout. Hydrophobic porous vent material can be provided in the container body if desired. In a related embodiment, a straw can be readily integrated into the above delivery system that provides multi-component mixing.

FIGS. 10C and 10D depict two embodiments of beverage container and closure system for multi-component beverages. The system provides a means to mix components in-situ upon initiation of fluid flow during consumption. In FIG. 10C, a two cavity container (176) is shown with partition (174) separating cavity (172) from (180). Hydrophobic porous venting matrixes are provided at one or more locations (168) (170). A straw (166) is provided so that the contents can be consumed with the container in a more upright position, if desired. The straw is joined at its base to porous mixing matrix material (182), which is selected to possess low to moderate water intrusion pressures. Upon consumption, components from cavity (172) and (180) enter matrix (182) and begin mixing while en route up the straw. The porosity of matrix (182) can be tailored to provide differing mixing ratios as required for the application. Optionally, a porous spill control matrix (177) is provided near the top of the straw, but can also be located at the straw base and/or entry ports of mixing matrix (182), or surrounding/encapsulating the mixing matrix.

FIG. 10D illustrates another embodiment for a multi-component beverage container/closure system. A recloseable drinking spout (184) is provided to the closure (190) along with hydrophobic porous venting matrix (186, 188) and a threaded closure body complimentary to the container body opening. A substantial layer of hydrophilic porous mixing matrix material (192) is provided at the proximal end of the fluid path. A small cross section of low water intrusion pressure porous material (194) is provided just distal to the mixing matrix material to provide anti-spill properties in addition to unwanted mixing of components. A partition (196) is provided that separates cavities (198) and (204). Additional container venting material (200, 206) can also be provided in the base of the container body as shown or along the walls of the container body.

Vented Beverage Closures for Aluminum Cans

FIG. 11 shows a vented closure for use with an aluminum beverage can. The closure is provided with an optional recloseable drinking spout (208), which is located off center near the opening of the can. A hydrophobic porous vent (210) is provided and may be located, for example, centrally or opposite of the spout location. The closure body is secured to the aluminum can body (218) by a locking mechanism (214) that engages the bead formed at the upper rim (212) located at the can's top. A snap fitting or other suitable attachment means may also be used. An optional straw (216) is provided that enables consumption of the contents in the can's upright position. With the straw, optional porous flow control matrix (220) is shown provided at the distal end of the straw to effect spill control.

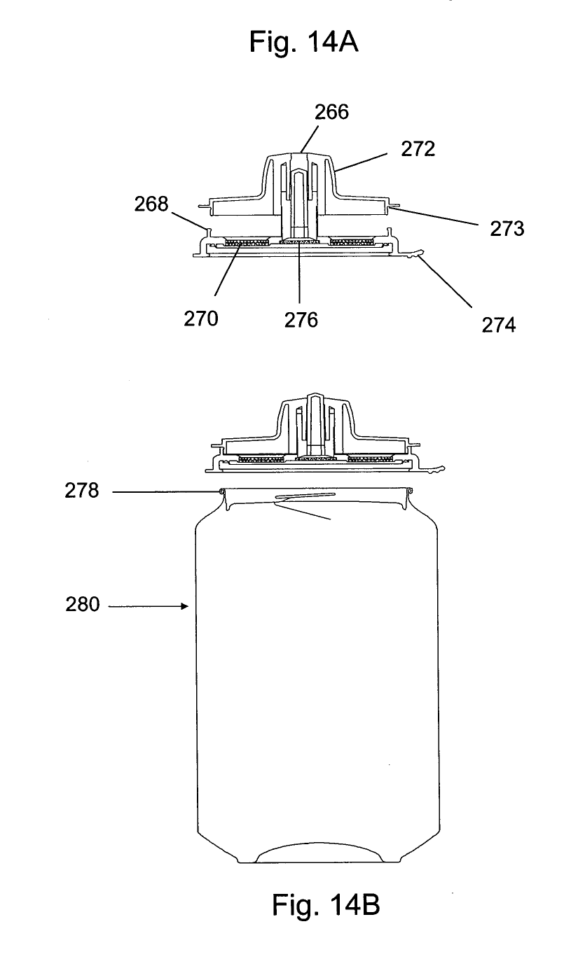

FIGS. 14A and 14B illustrates another embodiment for an aluminum can vented closure. A centrally located recloseable drinking spout is provide in addition to hydrophobic porous venting material (270) as shown in FIG. 14A. An optional porous flow control matrix (276) is located at the base of the fluid path and provides for anti-spill control. In FIG. 14B, the closure body is secured to the aluminum can body (280) by a locking mechanism (274) that engages the bead formed at the upper rim (278) located at the can's top. In FIG. 14A, the closure is shown in the open position with the seal (268) disengaged form the circumference of the closure body, allowing the porous vent material (270) to be exposed. The seal (266) at the spout tip is shown to be open in FIG. 14A. The combination recloseable vent and spout closure are advantageous in preserving beverage product freshness after can opening, especially with carbonated beverages and the like. The embodiments of FIGS. 14A and 14B may optionally incorporate a straw device (not shown) as the fluid path to provide for consumption when the container is in a generally upright position.

Hot Beverage and Food Container Closures: Re-Useable Food Storage Container Closures

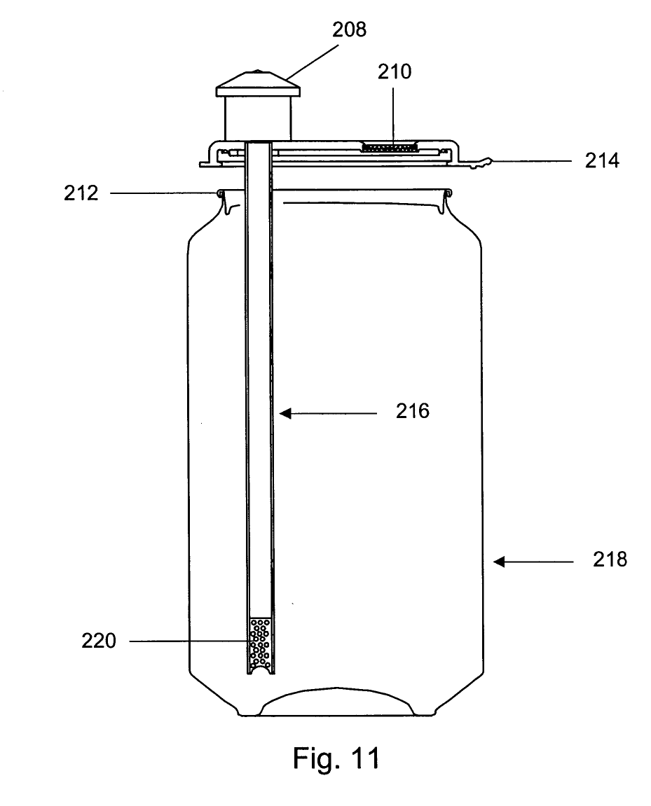

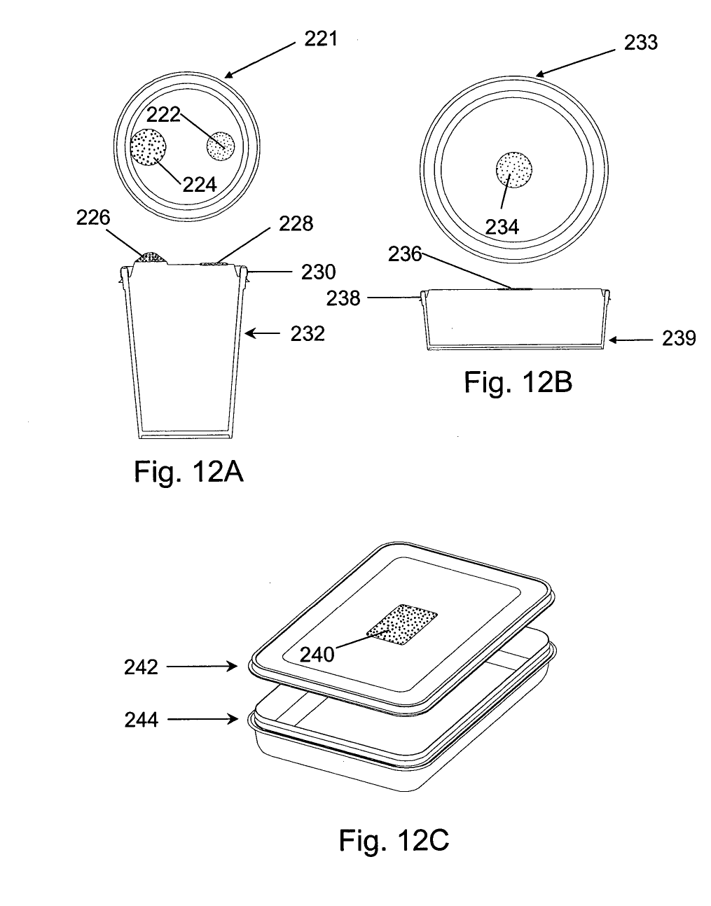

FIG. 12A depicts a hot beverage container closure system for use with disposable cups and the like. A container lid is provided with a porous hydrophobic vent material suitable for hot beverages. The vent (222) and (228) is located opposite of the porous drinking spout (224) and (226) and has high water intrusion pressures and high air flux rates. The drinking spout is made preferably from materials compatible with hot beverages, and has low water intrusion pressures and high liquid flux rates. The drinking spout can provide anti-spill properties by using a porous material with low to moderate water intrusion pressures. The vented closure is secured by a press fit along the rim (230) of the top of the container body (232). Similar closures may be used with non-disposable containers for hot liquids, such as travel mugs and the like. Another embodiment is shown in FIG. 12B. This type of container is suitable for take-out food/soup containers and contains a porous venting matrix (234) and (236) in the center of the closure. The closure is press-fit to the upper rim of the container body (238). The embodiment in FIG. 12B provides for venting of the container contents without risk of liquid leakage. The vent material is selected for temperature compatibility with hot food and liquids encountered during take-out. Although the venting material is shown in the center, it may be placed virtually anywhere on the closure.

FIG. 12C depicts one embodiment of food storage container, which can be reusable and/or disposable. The geometries may vary, being rectangular as shown or circular (not shown) or any other suitable shape. In FIG. 12C, a porous venting matrix (240) is provided in the center of the closure, which is secured to the container via a press-fit formed between the edges of the enclosure rim (242) and the edges of the upper rim of the closure body (244). Again, although the venting material is shown in the center, it may be placed virtually anywhere on the closure, and other methods of securing the closure to the container may be used.

Packaging Configuration for Carbonated Beverage Vented Closure

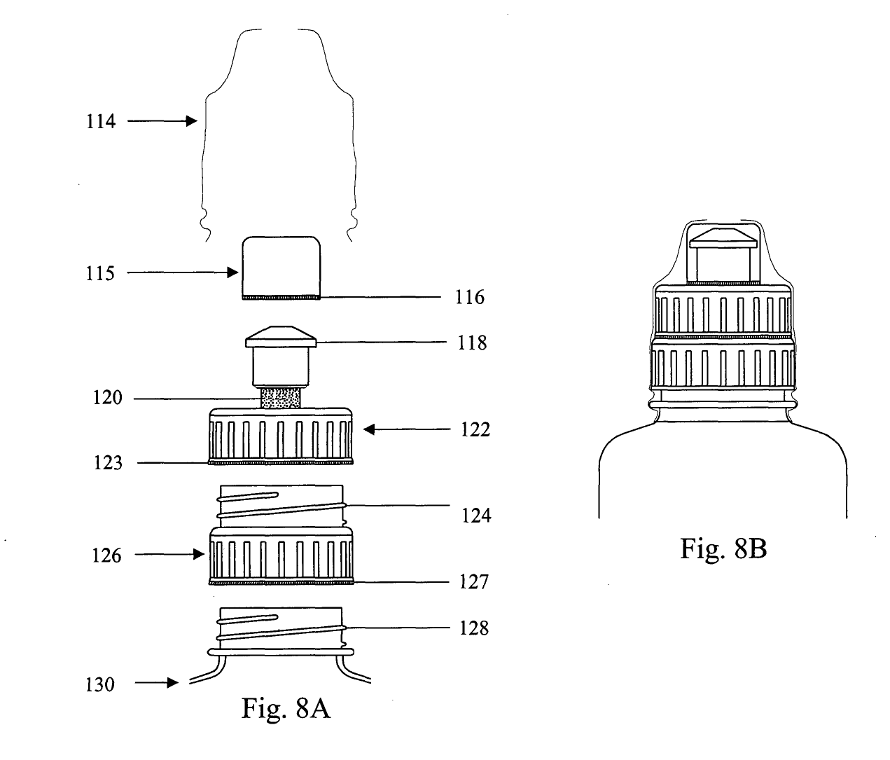

For carbonated beverages, the vented closures can be readily packaged by the bottler along with the container without loss of carbonation. In one embodiment of such closure, as shown in FIGS. 8A and 8B, a break-away design is incorporated into the mid-section of a container closure assembly that provides separation of the vented closure from the disposable primary storage closure. Once liberated the vented closure is secured to the container body before use. FIG. 8A is an exploded view of the final packaging configuration for a preferred vented closure containing a recloseable, preferably telescopic, spout (118), porous vent matrix (120), threaded vented closure body (122) with complimentary threads to opening (124) of primary closure body (126). In FIG. 8A a double closure stack is shown shrink-wrapped (114) with protective capsule (115) placed over spout (118) and secured to the top of the vented closure (122) with a break-away, twist, or pull-off mechanism (116). The vented closure body (122) is joined to the primary closure (126) with a break-away, twist, or pull-off mechanism (123). The primary closure (126) is secured to the container body (130) by a threading mechanism, and has provisions for a break-away, twist, or pull-off mechanism (127) to ensure integrity of the contents. The primary closure is engineered to support the maintenance of carbonation within the beverage after packaging and during long-term storage. In use, the primary closure assembly is initially separated from the container body first, followed by separation of the vented closure from the primary. Then, the primary closure is removed and discarded followed by securing the vented closure to the container opening. In an alternate embodiment, the primary closure is eliminated and a secondary seal, such as a peel away foil seal, covers the opening of the bottle or the inside of the vented closure body. FIG. 8B shows the final packaging configuration with a protective shrink-wrap over the double closure stack that can also be used to ensure product integrity in addition to the mechanism shown in (127).

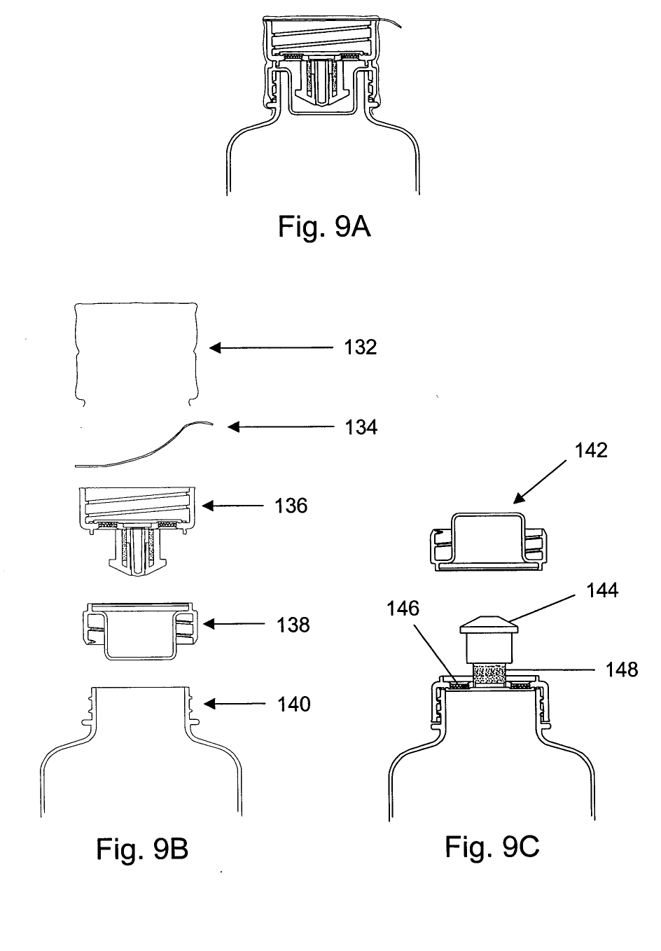

In another embodiment described in FIG. 9A, a vented closure is stowed within the neck of a closed container, and protected from its contents by the means of a sealed and disposable capsule. In FIG. 9B, the protective capsule (138) is secured to the threaded container opening (140) forming a gas tight seal using conventional techniques to those familiar with the art such as elastomeric liners, compression seals, interference fits and the like. The vented closure (136) is advantageously stored in the hollow of the protective capsule (138). The capsule-closure assembly can be further packaged by placement of a protective and removable heat seal (134) to which and over-wrap or shrink-wrap (132) can be optionally applied for tamper evidence. Additionally, a break-away seal (not shown) could be placed at the union of the capsule and vented closure bodies. A further option (not shown) could employ a rigid protective cover to protect the top side of the assembly that could be press fit or threaded onto the outside of the protective capsule. In practice, after removal of the protective over-wrap from the capsule-closure assembly is removed from the container body, then the capsule is separated and disposed of. The remaining closure is then secured to the threaded opening of the container body and readied for consumption, as shown in 9C. The beverage is dispensed through the spout (144) while venting is provided by the vent matrix (146) and flow matrix (148) is optionally provided. The protective capsule (142) may be used as a covering to preserve cleanliness of the spout.

Multifunctional Carbonated Beverage Closure System

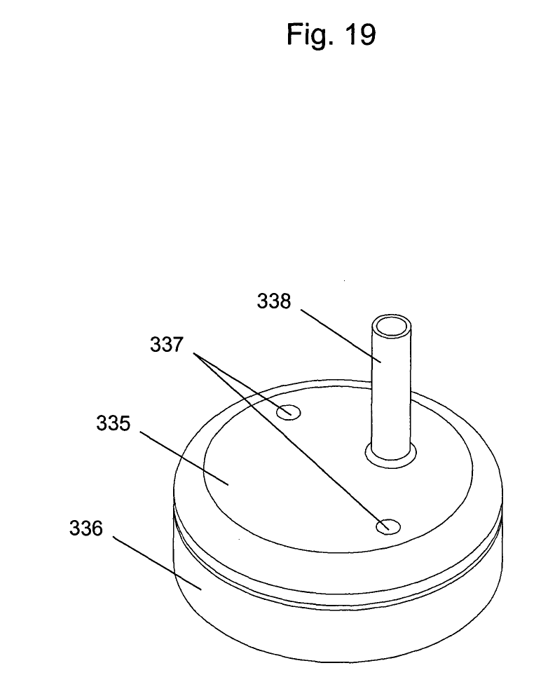

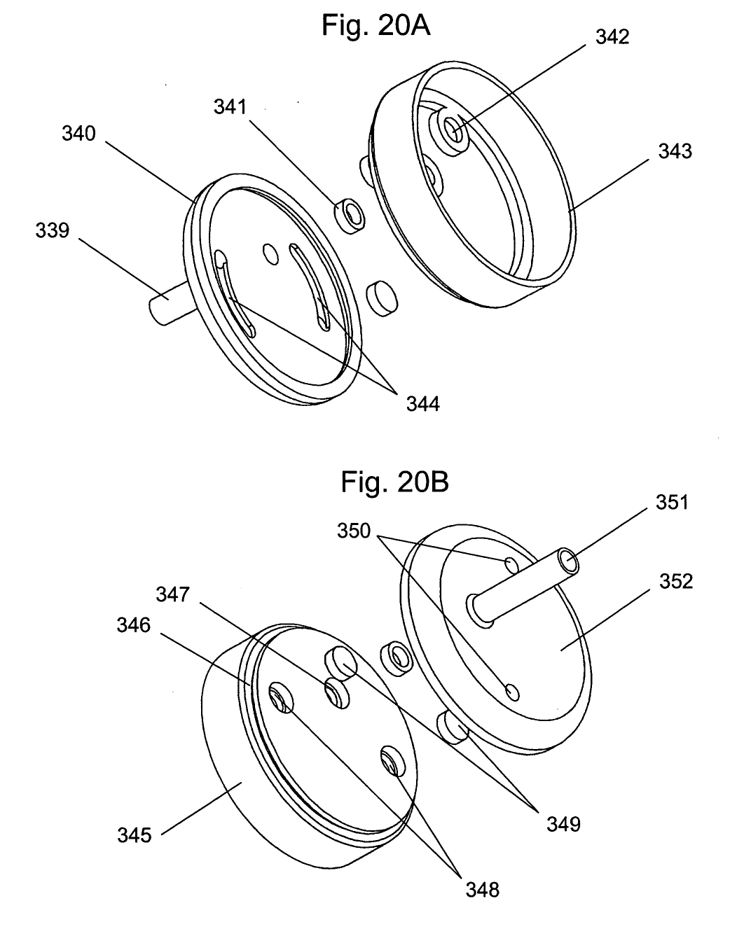

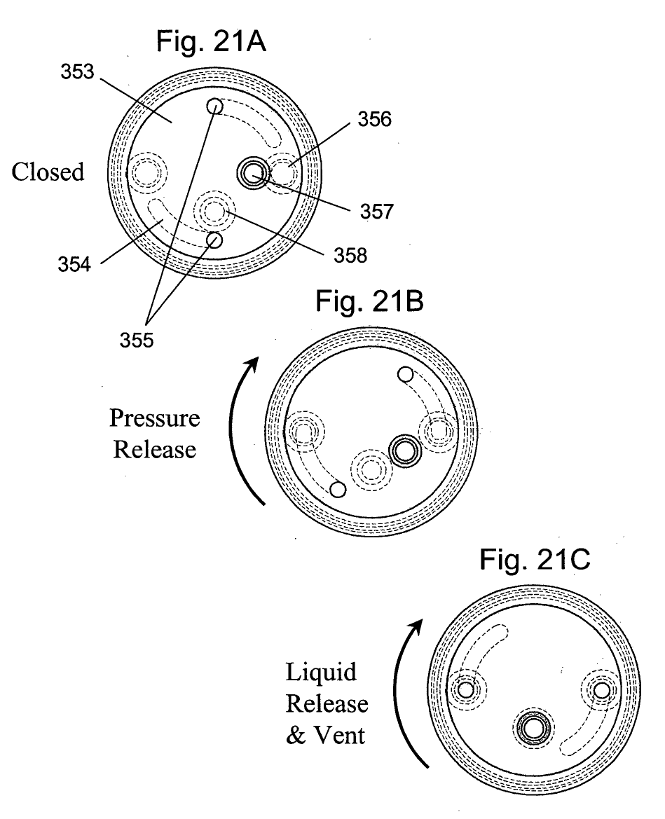

FIGS. 19, 20A and 20B, 21A, 21B, and 21C show a multifunctional carbonated beverage closure system suitable for the primary closure of carbonated beverages upon bottling, through shipping and long term storage by the consumer. By rotation of the cap out of its storage position, the carbonated closure functions to safely release excessive pressure through the porous matrix, thereby containing liquid and any foam within the beverage container. Both foam and liquid are advantageously prevented from passage through the hydrophobic porous matrix to the outside. By rotating the cap once more, the vents remain open while a liquid pathway is aligned through the closure to advantageously allow consumption or delivery of beverage. In FIG. 19, the closure top (335) is shown with two vent holes (337) and a fluid delivery spout (338) protruding outwards in relationship to the closure base (336). Not shown are alternative configurations that allow for closing and resealing of the spout. FIGS. 20A & 20B show the exploded view of the carbonated beverage closure with one of the two vent holes (342) shown in the closure base (343), and the same two vent holes (350) in the closure top (352). The liquid ring seal (341) provides a leak free path for the beverage fluid to flow from the container through the spout (339), and is located in the recess (347) of the closure base (345). The hydrophobic porous vent discs (349) allow for the equilibration (pressure or vacuum) of the container with the outside atmosphere, and are located within the recesses (348) of the closure base (345). In an alternative configuration (not shown) the hydrophobic discs are integral to the closure top (340). Venting grooves (344) allow for the passage of gasses between the closure base (345) and the closure top (340). A rotational snap groove (346) is located at the top edge of the closure base (343). The groove provides a compressive seal that is maintained between the closure top (352) and closure base (345) during rotation of the closure top to various positions shown in FIGS. 21A through 21C. FIG. 21A shows the top view of the closure in the closed position with the closure top (353) shown with a transparent view revealing the venting grooves (354), the liquid ring seal (358) in between the vent holes (355), and the spout (357) near the hydrophobic porous disc (356). FIG. 21B shows the closure having been rotated to a second position allowing the hydrophobic porous venting materials (disks) to align with the venting grooves, thereby allowing safe release of pressure from the container without liquid loss from the container. FIG. 21C shows the closure having been rotated to a third position which allows venting to continue while enabling the passage of beverage liquid through the aligned spout.

Vented Delivery and Flow-Through Beverage Purification and Filtration System

In a further embodiment, porous materials are used to provide a device capable of purifying or filtering a beverage while simultaneously venting the container. Preferred porous plastic materials are fabricated into container closures to provide venting during consumption. In addition, selected porous plastic materials, sometimes referred to herein as a treatment matrix or porous treatment matrix are fabricated into one or more compartments integral to the container closure, to provide a means for chemical treatment including adding a chemical or chemical treatment agent and/or removal of contaminants. In one embodiment, treatment matrices in the form of porous plastic materials are fabricated to remove substances from a flowing liquid stream using selective, non-selective, or reactive separation mechanisms, or combinations thereof. In another embodiment, porous materials are selected to provide on-demand mixing of two or more beverage components with simultaneous container venting. Preferred hydrophobic porous materials are selected or fabricated so as to provide a minimum liquid intrusion pressure to commence liquid flow of multiple beverage components during consumption (i.e. a non-mechanical check valve). In addition, a preferred porous material with random interconnected pores forming a tortuous path internal structure is preferentially positioned to provide static mixing of the beverage components. Moreover, a preferentially porous material is provided in the closure or the container body to provide venting during beverage consumption. The delivery system can also be used to provide in-situ carbonation in addition to general mixing of two or more components.

Hydrophilic porous materials are used as a support matrix to provide a means to separate or filter components from a beverage solution, advantageously when combined with hydrophobic venting material from the closure. Active hydrophilic porous materials are preferably positioned within the closure to provide dynamic separation during liquid flux across the matrix via the random network of interconnected pores in communication with the inside and outside of the container. The dynamic separation process can be selective or non-selective for removal of desired beverage components. Examples of selective removal include anionic and cationic exchange, size, affinity, and reactive separations. Hydrophilic porous materials with ion exchange properties can be generated from a co-sintering process familiar to those in the art. Moreover, those skilled in the art of surface modification can readily treat porous materials to contain chemical or catalytic species anchored to the surface of the pores for the purpose of providing dynamic separation or filtration capabilities.

Active hydrophilic porous materials are easily incorporated into beverage container closures, and advantageously combined with closure venting to provide consistent fluid delivery during consumption without vacuum buildup inside the container. Active hydrophilic porous materials are suitable for the removal of contaminants, disinfectants, or other targeted beverage components such as chlorine, iodine, peroxide, caffeine, sodium, alcohol, etc., from a flowing beverage liquid stream. In a preferred embodiment, the porous structures used have one or more or all of the following properties: random interconnected pores in communication with the beverage and outside of the container; average pore sizes ranging from about 0.5 to 500 μm, including between about 5 and 250 μm; percent porosity of about 10 to 90%, including between about 50 and 90%; high surface areas, preferably between about 0.1 and 1000 m²/g, including between about 100 and 1000 m²/g; and generally high surface energies, with surface tension values ranging between about 40 and 80 dynes/cm^{2,}, including between about 50 and 70 dynes/cm². The combination of one or more or all of these factors in embodiments that are used directly for drinking produces liquid flux rates capable of delivering flow rates of about 50 to 4000 ml/min of beverage, including about 500 to 2000 ml/min and about 1000 to 2000 ml/min.

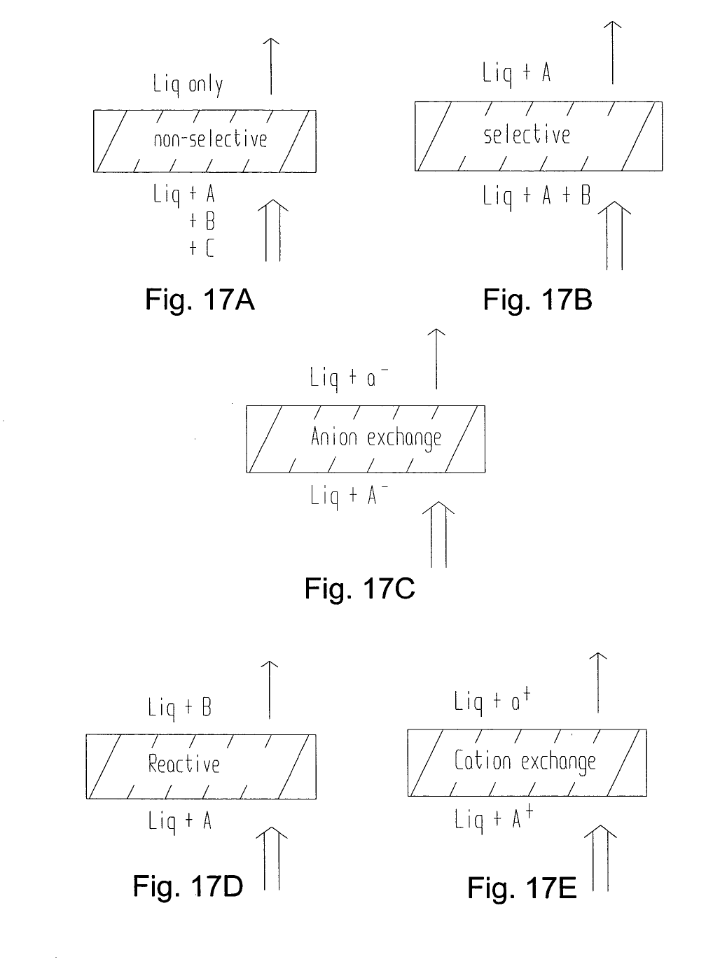

There are a variety of techniques designed to filter liquids that can be applied to the purification of beverages. FIGS. 17A through 17E depict preferred embodiments based on the most common liquid separation methodologies. FIG. 17A provides a porous matrix that is non-selective for impurities based on chemical make-up. The non-selective matrix can be used to separate out all organic compounds for example by providing a porous matrix derived form activated carbon. In another example, the size of the pores can be used to “sieve” out particles of various sizes regardless of the chemical composition. FIG. 17B provides a porous matrix that can selectively remove one or more type of specific contaminants. This can be accomplished through affinity type mechanisms based on intermolecular binding, polarity, magnetic, and other properties. FIG. 17C provides a porous matrix that separates contaminants based on the presence of a net negative charge followed by replacement with a specific new chemical entity with a net negative charge. This process is known to those familiar with the art as anion exchange. Similarly, a net positive charge exchange process (FIG. 17E) known as cation exchange may also carried out with porous materials to separate liquid contaminants. The final type of separation process is based on a chemical reaction that transforms the contaminant into a new chemical species, which is preferably benign. The term reactive separation is used to describe the process to those familiar with the art and is illustrated with a porous matrix shown in FIG. 17D.

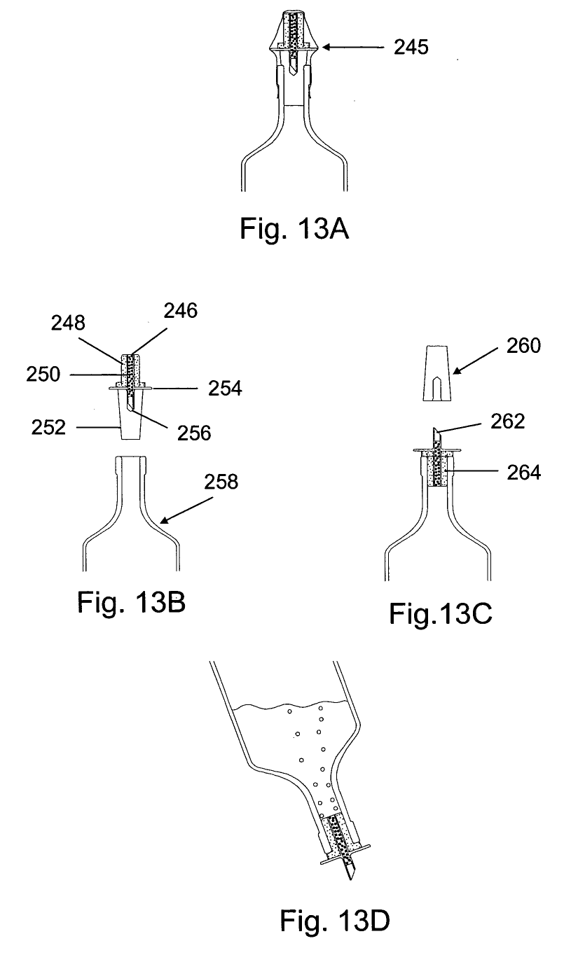

The purification processes performed by the embodiments shown in FIGS. 17A through 17E are advantageously incorporated into porous matrix materials for simultaneous purification and venting involving dispensing of liquid beverages. One preferred embodiment is shown in FIGS. 13A through 13D for the purification of wine by removal of preservatives such as sulfites, bisulfites, and sulfur dioxide. The preservatives are essential for long term storage of the wine, but have many drawbacks to the wine consumer including allergic reactions, chemical sensitization, pungent flavor and odor, and masking of the natural but subtle flavors present in the wine. To provide more enjoyment of the wine, it would be advantageous to have a dispensing device or wine bottle closure that would be packaged with the wine bottle when purchased, that would add little or no cost to the wine product, that could purify the wine during dispensing from its original container, and provide a method to seal the contents if desired.

In FIG. 13A, the final packaged wine closure is depicted with an over-wrap (245) of metal foil or a plastic sleeve. FIG. 13B shows how the packaged closure cork assembly is separated from the wine bottle (258). The assembly comprises a vented purification closure (248) joined to the cork (252). The vented closure has the purification porous matrix (250) centrally located (246) within the vented purification closure. The purification matrix is highly porous material with high liquid flux rates and low water intrusion pressures with pore surfaces amenable to separating the wine preservatives. After removal of the closure cork assembly, it is inverted and re-secured to the wine bottle opening as shown in FIG. 13C. The cork is separated form the vented purification closure, which is left behind in the neck of the bottle opening by a compression or interference fit. The delivery stem (262) is shown and contains the purification matrix. The shoulder of the vented purification closure (264) contains the porous venting matrix, which also runs along the length of the closure body so as to provide communication between the outside and inside of the container. FIG. 13D shows the venting action of the closures upon dispensing of the wine by inverting the bottle.

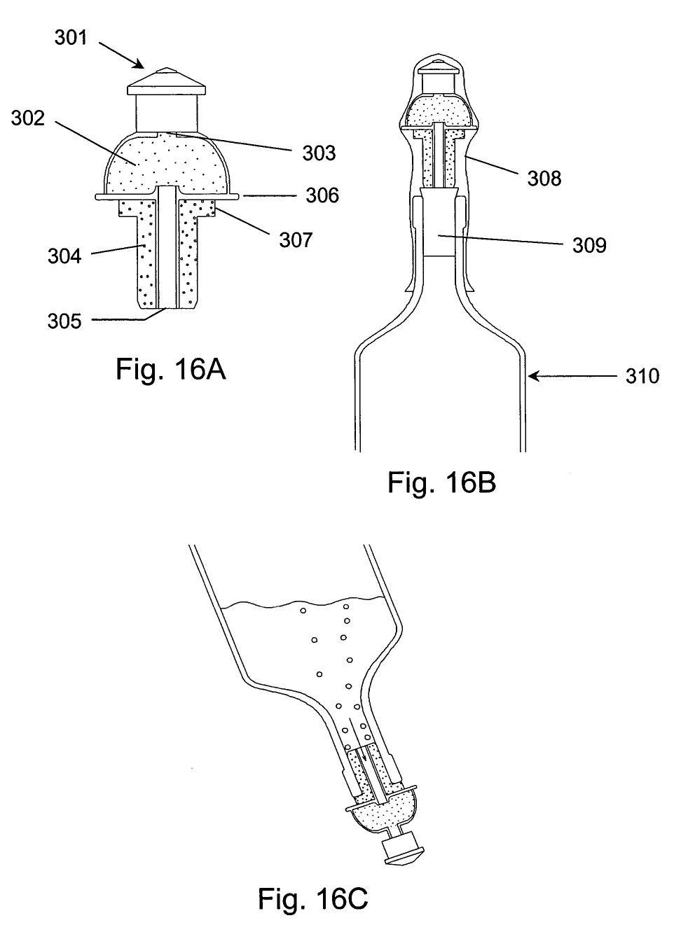

FIGS. 16A through 16C depict another embodiment of vented purification closure such as for dispensing wine. The packaged closure is shown in FIG. 16B with foil wrap (308) over the cork assembly and bottle's neck. The cork (309) is also shown and is still used as the primary closure. The vented closure is depicted in FIG. 16A, and contains a recloseable spout (301), a purification chamber (302) a porous venting jacket (304) and shoulder (307). FIG. 16A is a cutaway view of the vented closure showing the spout (301) the purification matrix (302) fluid exit path (303) porous venting and shoulder (304, 307) and open liquid delivery path (305). Again, the porous purification matrix has a high liquid flux rate, low water intrusion pressure, and is chemically suited for purification of wine preservatives such as sulfites and its related species in solution. The vented porous jacket and shoulder is constructed from porous hydrophobic materials with high water intrusion pressures and high air flux rates. FIG. 16C shows the spout in the open position with concurrent venting. Knowing this, a combination of venting, purification, and disinfectant delivery can be advantageously combined using an integrated system of porous materials to introduce disinfectants into a beverage, and selectively remove the disinfectant during consumption of the beverage from its container while providing simultaneous venting for a pleasurable drinking experience. Also knowing this, it should also become apparent to combine other types of solute delivery schemes into the porous materials for introduction into the beverage container to include medications, flavorings, colorants, vitamins, or herbal remedies, in addition to having the porous materials to provide purification and venting capabilities.

Vented Beverage Closures for High Volume Manufacturing/Bottling

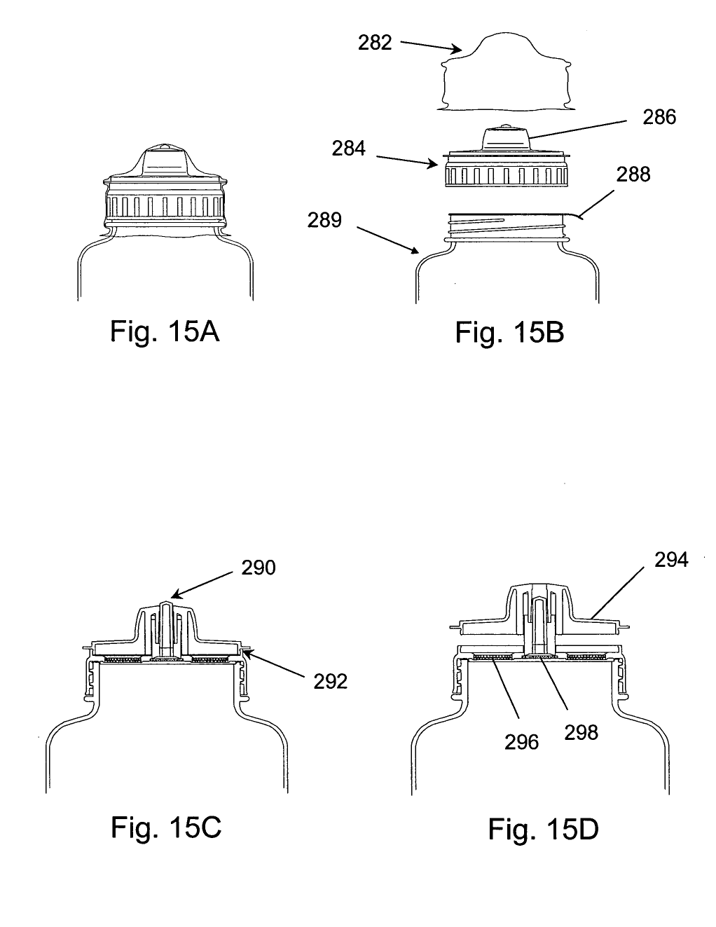

FIGS. 15A through 15D depict a preferred vented beverage closure having recloseable vent and fluid paths. The final packaged configuration is shown in FIG. 15A with a protective shrink-wrap (282) over the closure (284) shown in FIG. 15B. The closure body contains threads complimentary to the threads in the bottle opening for securing. In alternative embodiments, suitable closures other than threaded closures may be used. An optional secondary protective seal (288) may also be used to provide additional protection for product integrity. The closure body contains a drinking spout (286) centrally located and recloseable at its tip. FIG. 15C shows the cross section of the closure with recloseable mechanisms provided at the closure circumference (292) and drinking spout tip (290). The combination recloseable vent and spout closure is advantageous in preserving beverage product freshness. FIG. 15D depicts the closure in the opened position (294), exposing porous vent matrix material (296). Porous fluid control matrix (298) is positioned within the fluid path or may be omitted.

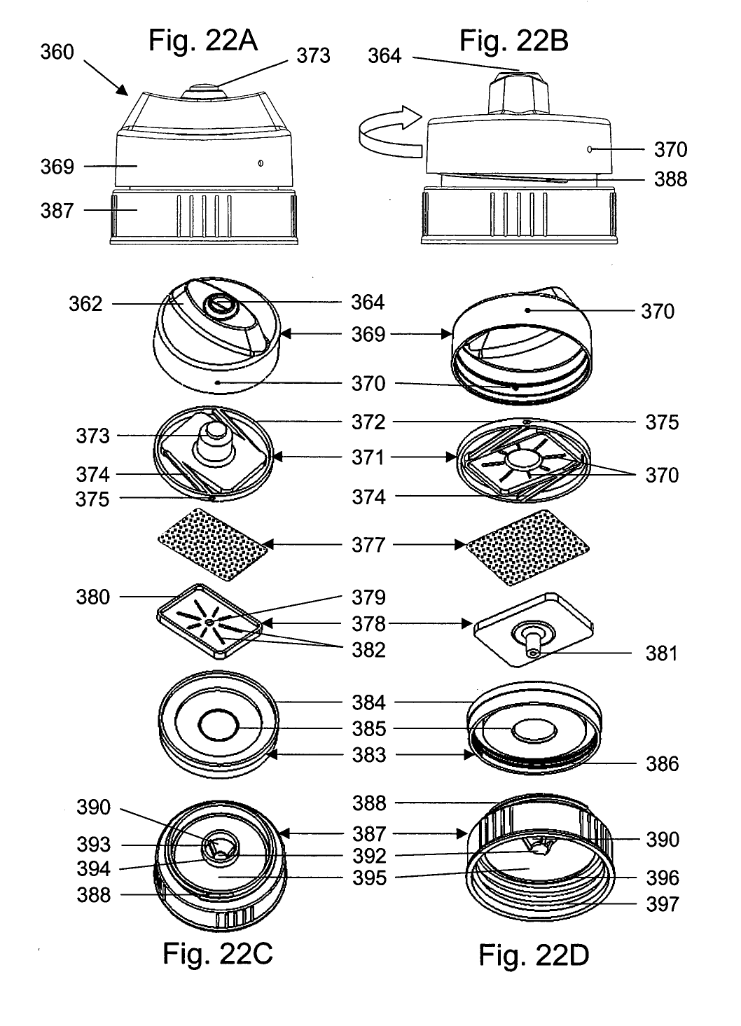

FIGS. 22A through 22D illustrate a vented beverage dispensing closure. The closure embodiment, including the vent material, is advantageously assembled entirely using snap-fit or press-together techniques, and so is highly amenable for high volume manufacturing. The rectangular shape of the vent material is advantageous for manufacturing as it virtually eliminates the generation of scrap venting material compared to round geometries. Reduced scrappage greatly helps to lower production costs in high volume manufacturing. Moreover, as may now become realized with those familiar with the art, centrally locating the porous vent material allows for the most efficient usage of material, a further advantage and cost savings in high volume manufacturing. The vented closure embodiment of FIGS. 22A through 22D has liquid and air vent shut-off control features actuated by twisting the cap relative to the base housing. This advantageous configuration allows the air venting passage to be located on the center axis and the liquid fluid path radially, so as to reduce air entrainment within the distal segment of liquid flow. Air and liquid separation axially is important to reduce entrainment followed by subsequent consumption of aerated beverage. Reversing the convention of central fluid flow to the periphery further enhances the drinking experience when consuming beverages from containers with vented closures. Although discussed in connection with a particular set of embodiments herein, other closures described herein may be adapted to use reverse flow in view of the discussion which follows. This “reverse-flow” arrangement greatly reduces the formation of turbulent flow conditions near the fluid path inlet of a vented closure. Factors attributed towards the development of turbulent flow include the dispensing angle of the inverted beverage container, liquid consumption rate, air return rate, orifice size and number of air return ducts, degree of axial and latitudinal separation between air return and liquid entry into fluid path. Inherent to a vented closure design is therefore the existence of a “critical orifice”; a dimension that when exceeded can lead to the development of turbulent flow and entrainment of air into the fluid path. For example, two vented “reverse flow” closures of the type in FIG. 22A were fabricated with a 28 mm bottle thread finish. One of the closures had an orifice sized at 1/16″ and the other at ⅛″. Two bottles were charged with 500 ml of water, upon which each closure was secured to its bottle. The bottles were then inverted so that they were completely upside down and vertical (90 degree with respect to the horizon). The time to empty each bottle's contents was noted in addition to presence of air entrainment in the water as shown in Table 1 below:

TABLE 1

| Orifice Size | Time to Empty (sec) | Air Entrainment? |
|---|---|---|
| 1/16″ | 60 | No |
| ⅛″ | 15 | Yes |

According to Table 1, doubling the orifice diameter resulted in air entrainment into the liquid beverage. Therefore, a “critical orifice” exists for the design somewhere between 1/16″ and ⅛″ diameter. Knowledge of the “critical orifice” is advantageous in designing vented beverage closures for the most pleasurable drinking experiences. The use of the term “critical orifice” is not intended to imply that a specific orifice is necessary or critical to the functioning of the embodiments herein. It is simply a term used to describe a size or range of sizes of orifice that provides less turbulent flow; closures according to many embodiments may have generally turbulent flow or they may be designed with the concept of “critical orifice” in mind.

The Reverse-Flow closure design features of FIGS. 22A through 22D include centrally located rectangularly shaped (other shapes are possible) hydrophobic porous vent material (377), captured between vent housing inlet (371) and vent housing outlet (378) to create a sealed subassembly with two vent inlet ports (375), and a vent inlet duct (381). Ports (375) and duct (381) are in direct connection with vent material (377) in series. The vent material (377) is held off the flat surface of the components (371) and (378) by the protruding ribs, items (382) and (370). This separation aids proper function of (377). The porous vent (377) is sealed by the function of seal (380). Subassembly, (371), (377), and (378) are first pressed into the distal cap (369) and then cover seal (383) is pressed into distal cap (369) covering subassembly of vent housing inlet (371), vent (377), and vent housing outlet (378). The base housing (387) is than added to the assembly to make it complete.

After assembly, exterior vent passage port (370) is the inlet for air which is in direct connection to port opening (375) which passes through the flexural vent duct (374) and is in direct contact with the inside of the vent housing and protruding ribs (370). Air will pass through the porous hydrophobic filter to reach distal air duct (381). When the closure device is in the closed mode (FIG. 22A) port (381) is sealed by the contact of sealing surface of item (392), vent/valve seat. When the closure device is in an open mode (FIG. 22B) air will leave duct (381) and travel through opening (390) and into the inside of the bottle to replace the displaced fluid until a pressure equilibrium is reached.

Item (371) is preferably flexible in section (374). This flexibility allows the outer sealing/anchoring ring (372) to be fixed to item (369) and the center portion of item (371) can move in a axial direction relative to the sealing/anchor ring. Passages (374), will twist and contort to give axial motion. When the closure device is in the open mode, liquid flowing and air venting) there is no axial displacement/flex of the part (371). As the closure distal cap assembly is closed, duct (381) will come in contact with surface (392) and seal via a self centering cone and sealing seat under load. As the closing mode continues the center section of item (371) is axially displaced because of contact to duct (381), and will continue axial movement until cylindrical sealing surface (373), is seated into opening (364). The twist action closure will have mechanical stops to limit the amount of travel open and close of the device and insure proper axial movement to sealing air and liquid.

Item (369) is the distal component collecting and directing the fluid out opening (364). Item (369), (371), (377), (378) and (383) will make a complete subassembly that will be attached to item (387). The shape (362) is in a manner that is ergonomic to the lip when drinking. Item (364) is an opening for fluid to pass through when closure device is in an open mode and is also an annular interference fluid seal with item (373) when the device is in a closed mode. Item (383) is a cover to enclose fluid compartment of the upper assembly and a dynamic seal (385) to seal to cylindrical sealing surface (394). Item (384) is a compressive hoop seal and lock for components. Liquid flow during use begins through opening (390), past or around item (371) and out distal port (364). Open and Close actuation is by means of matching thread (386) inside item (383) of the upper assembly and threads (388) of the base housing. A 90 degree twist action is used in this configuration to open and close valves or passages.

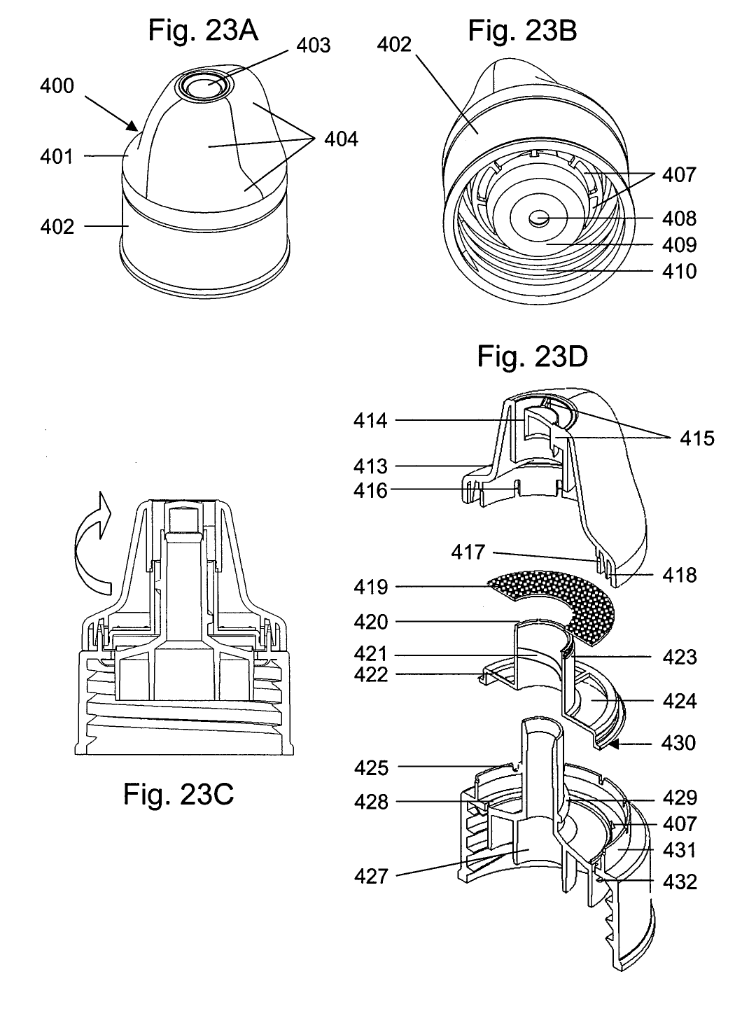

FIGS. 23A through 23D illustrate a reduced complexity vented beverage dispensing closure. The closure embodiment's final assembly is performed using snap-fit or press-together techniques, and so is highly amenable for high volume manufacturing. Depending on the manufacturer's capabilities, the embodiment can be produced in either of two ways. The first method requires the use of insert molding techniques, whereby the hydrophobic porous vent material (419) is placed into an injection mold prior to the introduction of resin to produced the vent insert support (430). Again, depending on the manufacturer, robotics can be employed to pick and place the flat donut shaped vent material versus manual insertion. The use of robotics is highly advantageous for large scale manufacturing involving injection molds with high degrees of cavitation. It may also become apparent to those who practice the art to employ a type of continuous or intermittent molding process in which a continuous strip of porous vent material is passed between a pair of complimentary molding cavities via a tractor feed mechanism provided by the presence of notched grooves along the sides of the strip or holes strategically punched in the middle of the strip. In this scenario, the center part (430) can be molded directly to the continuous strip of porous material when the molding cavities come together, and subsequent to exiting the molding cavities upon their opening, a cutter can be employed adjacent to the mold exit path thereby liberating the finished part from the continuous strip. The tractor feed process is also amenable to molds with high cavitation, and so can also be employed in large volume manufacturing operations. The remaining components, cover (401) and base (402) are manufactured using injection molding techniques familiar to those who practice the art. The final three pieces are subsequently assembled using the snap-together techniques previously discussed.

The second method involves producing all three pieces (401), (402), and (430) using standard injection molding techniques familiar to those who practice the art. Prior to assembly, the hydrophobic porous vent material (419) is attached to the centerpiece (430) preferably using techniques amenable to high volume manufacturing such as ultrasonic or laser welding. Other attachment techniques can be employed as previously discussed. Then, the resulting three pieces (401), (402), (419, 430) are snap assembled as previously discussed. The vented closure embodiment of FIGS. 23A through 23D contains integral liquid and air vent shut-off control features actuated by twisting the cap relative to the base housing. This advantageous configuration allows the air venting passage to be peripherally located about the center axis, and the liquid fluid path centrally located with its fluid port (408) but, significantly elevated with respect to the air return ports (407) so as to reduce the probability of air entrainment within the distal segment of liquid flow into the duct (427). Air and liquid separation by elevation is also used to control air entrainment into flowing liquid.

The embodiment of the reduced complexity vented closure depicted in FIG. 23A includes the closure (400) opening of fluid spout (403) centrally located atop of the ergonomically shaped (404) closure cover (401) in communication with threaded base (402). In FIG. 23B, the bottom view reveals the air return ports (407), air deflector housing (409), fluid port (408) and integral threads (410) for securing to bottles. The closure can be actuated to the opened position by turning or twisting the cover (401) with respect to the base (turning 14 turn in the illustrated embodiment) (402), which causes the cover containing centerpiece (430) in FIG. 23D to rise in elevation along the threaded guide (429) by action of the groove (421) within the vent insert support post. In FIG. 23D, the duct seal (414) is held in position by the duct seal supports (415) that act when the cover is in the closed state, thereby providing a liquid tight seal within the fluid path. The radially located air channels (416) contained within annular cover seal (417) are shown placed slightly inwards of the annular vent outer seal wiper (418), which pushes against the annular base seal (431) upon actuating the cover to the closed position, thereby causing an air-tight seal to be made between the knife edge of the base seal (431) wedged between the annular seal wiper of the cover (418) and the annular cover seal (417). Wedging of the base seal is accomplished from the downward travel of the cover during rotation to the closed position. In the open position, the cover travels upward, and air can flow when the channels (425) align with the channels (416) in the cover (413). The flowing air is then forced through the hydrophobic porous venting material (419) because of inner annular seal (420), resulting in air flow through the vent opening (424) within the vent insert support (430), containing several support struts (422). From here, flowing air is guided into the air return ports (407) of the base (402) where a seal (432) is acting upon the rim of the container opening affording a liquid and air tight seal while secured to the bottle. The influx of air then acts to neutralize the buildup of vacuum within the beverage container to afford a pleasurable drinking experience.

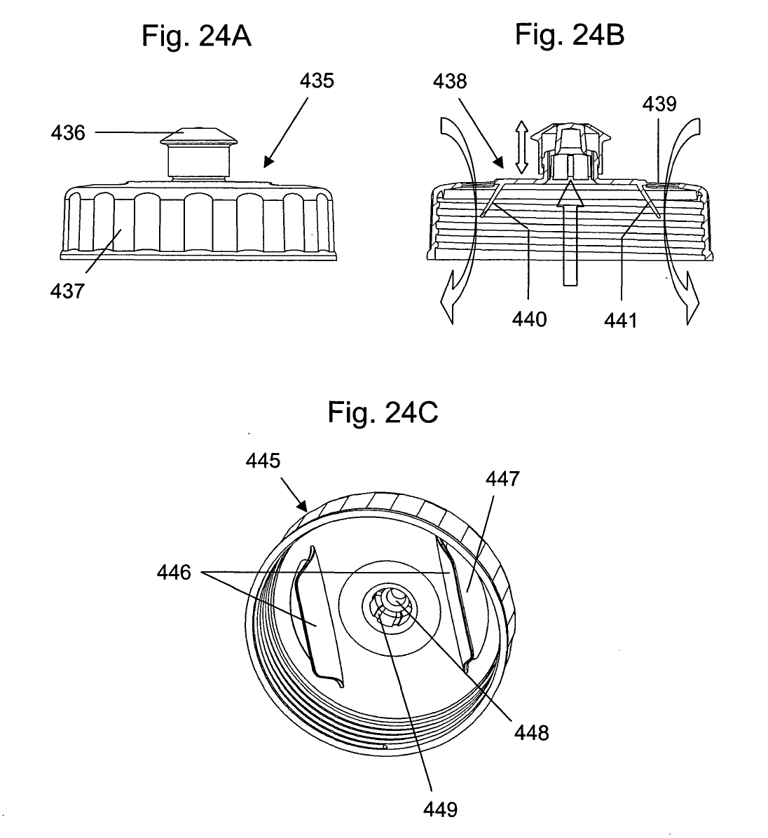

FIGS. 24A through 24C depict a larger sized vented beverage closure most preferably suitable for reusable sports type beverage containers. The closure (435) in FIG. 24A contains a reclosable spout (436) and grooves on the circumference to assist with securing to an appropriate sports bottle. The spout can be actuated by twisting or by using push-pull movements as shown in FIG. 24B. Both closure and sports bottle are made of plastic materials, and preferably plastic materials that can be washed by hand with soap and water, and most preferably from plastic materials that can withstand the rigors of household dishwasher cleaning cycles and detergents to allow for reuse of the closure and bottle. Examples of preferred plastic materials, and properties of such materials, are listed hereinabove.

In FIG. 24B, the vented closure (438) is shown with provisions for hydrophobic macroporous vent material (439), which allows air to enter and pass through the cap body. Strategically located air flow deflectors (440) and (441) function to deflect air away from the fluid path and thereby reduce the likelihood of air entrainment into the dispensed liquid beverage. FIG. 24C details the bottom view of vented closure (445) showing the position of hydrophobic porous vent material (447) situated just above air deflectors (446), with distal fluid (449) and proximal fluid paths shown (448).

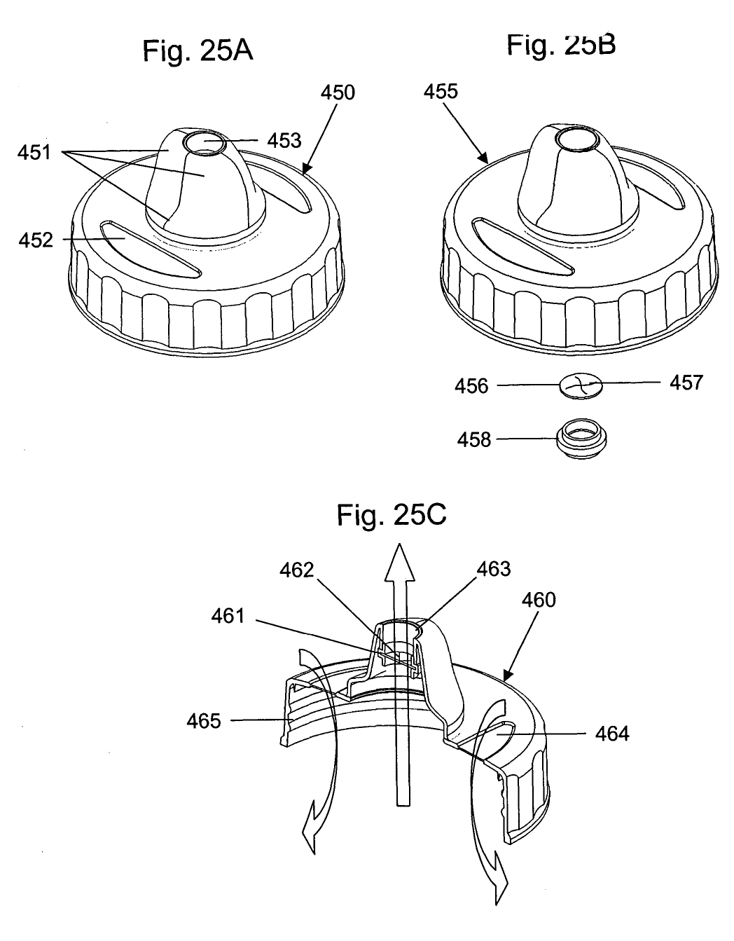

FIGS. 25A through 25C are ergonomically designed vented closures preferably designed for use with reusable sports-type beverage containers. In FIG. 25A, the closure (450) spout is centrally located and has a comfortable ergonomic shape (451) that enhances the drinking experience. The self-sealing spout is designed to remain in a fixed position so that opening or closing is unnecessary in preventing beverage flow. Venting of the closure is provided by vent material (452) located near the edges of the closure body. Fluid is designed to exit at the spout location (453) upon dispensing. Dispensing is accomplished by consuming the contents, for which the self sealing valve is designed to open its elements thereby allow liquid beverage flow to commence. Upon cessation of drinking, the valve's elements close and the liquid flow stops. In conjunction with venting, the drinking process remains uninterrupted for as long as the consumer desires. There is no vacuum buildup or strenuous squeezing of the beverage container required to maintain dispensing. FIG. 25B details the vented closure's valve assembly containing elastomeric element (456) with perforated slits (457) located within the element. The elastomeric element is retained within the fluid path by (458), which is mechanically joined and centrally placed within the fluid path by one or methods familiar to those who practice the art such as ultrasonically welding, rotational welding, adhesive bonding, press-fit, or other similar processes. FIG. 25C is a cross sectional view of the vented closure showing air flow through the vent (464) and fluid exiting the spout (463) after passing through the retainer (461) and elastomeric element (462). The closure may preferably contain air deflectors (not shown) to reduce air entrapment and enhance the drinking experience.

A series of experiments were conducted comparing the performance of various matrix materials. The containers were filled with 700 ml of water and the opening for dispensing (hence the area of the flow) was 0.71 square cm. The pressure drop from air venting only and during liquid dispensing was measured and is presented in Table 2. In preferred embodiments, pressure drop is preferably less than 2 psi, including less than about 1.2, 1.1, 1.0, 0.9, 0.8, 0.7, 0.6, 0.5 0.4, 0.3, 0.2, 0.1 and 0.05 psi. As can be seen in Table 2, the materials tested were well within the desired ranges.

TABLE 2
Pressure Drop Data From Inside Beverage Container
During Dispensing of Water

| | Ave | | | |
|---|---|---|---|---|
| Hydrophobic | Pore | Thick- | Pressure | Pressure Drop |
| Macroporous | Diam | ness | Drop from Air | During Liquid |
| Material Type | (um) | (in) | Venting Only (psig) | Emptying (psig) |
| HDPE | 120 | 0.0625 | 0.10 | 0.07 |
| HDPE | 110 | 0.0625 | 0.07 | 0.07 |
| UHMWPE | 30 | 0.0625 | 0.27 | 0.07 |
| HDPE | 35 | 0.035 | 0.28 | 0.07 |
| PP | 150 | 0.125 | 0.07 | 0.10 |
| PTFE | 30 | 0.125 | 0.77 | 0.10 |
| PTFE | 4 | 0.0625 | 0.60 | 0.13 |
| HDPE | 110 | 0.125 | 0.28 | 0.13 |
| UHMWPE | 7 | 0.025 | 0.73 | 0.20 |
| UHMWPE | 7 | 0.0625 | 0.70 | 0.23 |
| PTFE | 4 | 0.025 | 0.60 | 0.37 |
| PVDF | 0.5 | 0.004 | 0.63 | 0.67 |

The time to empty the container was measured and the flow rate and flux rate calculated and presented in Table 3.

TABLE 3
Liquid/Air Flux Rates

| Hydrophobic | | | Vented Container | | Flux |
|---|---|---|---|---|---|
| Macroporous | Ave Pore | Thickness | Empty Time for | Flow Rate | cc/(min * |
| Material Type | Diam (um) | (in) | 700 ml water (s) | water (ml/s) | cm\hat{ }2) |
| UHMWPE | 7 | 0.0625 | 26.23 | 26.69 | 632.89 |
| PVDF | 0.5 | 0.004 | 24.61 | 28.44 | 674.55 |
| PP | 150 | 0.125 | 20.88 | 33.52 | 795.06 |
| HDPE | 110 | 0.0625 | 20.60 | 33.98 | 805.86 |
| PTFE | 30 | 0.125 | 20.06 | 34.90 | 827.56 |
| UHMWPE | 7 | 0.025 | 19.75 | 35.44 | 840.55 |
| HDPE | 110 | 0.125 | 19.04 | 36.76 | 871.89 |
| HDPE | 35 | 0.035 | 18.41 | 38.02 | 901.73 |
| PTFE | 4 | 0.025 | 17.73 | 39.48 | 936.31 |
| UHMWPE | 30 | 0.0625 | 17.41 | 40.21 | 953.52 |
| HDPE | 120 | 0.0625 | 16.07 | 43.56 | 1033.03 |
| PTFE | 4 | 0.0625 | 15.36 | 45.57 | 1080.78 |

In Table 4, results of a leak test to determine whether there was visible leakage through the matrix material using carbonated soft drink (CSD) with and without 5% ethanol added.

TABLE 4
Leak Test

| Material | Liquid | Pore Size | Leakage |
|---|---|---|---|
| PTFE | CSD | 35 | Yes |
| PTFE | CSD | 2 | No |
| PVDF | CSD | 5 | No |
| PTFE | CSD + 5% ethanol | 2 | No |
| PVDF | CSD + 5% ethanol | 5 | No |
| UHMWPE | CSD + 5% ethanol | 7 | No |

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof.

What is claimed is:

1. A closure for dispensing fluids from a container, comprising:
a pair of telescopically coupled first and second members cooperatively defining a fluid path;
said first member attached to a base adapted to be secured to a container;
wherein the base and/or the first member include one or more sections of a porous vent material which allows passage of gases and inhibits bulk passage of liquid.

2. A closure according to claim 1, wherein the vent material comprises plastic, metal, ceramic and/or glass.

3. A closure according to claim 1, wherein the vent material comprises a hydrophobic material.

4. A closure according to claim 1, wherein the vent material comprises a plastic material having a high water intrusion pressure.

5. A closure according to claim 1, wherein the porous vent material provides sufficient venting to allow a substantially continuous liquid flux rate from the closure without creating a substantial pressure differential across the closure.

6. A closure according to claim 1, wherein the porous vent material provides sufficient venting to allow a substantially continuous liquid flux rate from the closure of at least about 50 ml/min/cm².

7. A closure according to claim 1, wherein the porous vent material provides sufficient venting to allow a substantially continuous liquid flux rate from the closure of at least about 500 ml/min/cm².

8. A closure according to claim 1, wherein the closure provides a pressure drop during dispensing of less than about 2 psi.

9. A closure according to claim 1, wherein the closure provides a pressure drop during dispensing of less than about 1 psi.

10. A closure according to claim 1, further comprising a porous flow matrix within at least a portion of the fluid path, wherein the flow matrix is adapted to substantially inhibit flow of liquid through the flow matrix unless an air pressure differential exists between inside and outside a container to which the closure is attached.

11. A closure according to claim 1, wherein the air pressure differential is about 0.05 to 2.0 psi.

12. A closure according to claim 1, wherein the first and second members are generally tubular.

13. A closure according to claim 1, wherein the fluid path is opened to allow fluid flow out of a container by moving the second member relative to the first member

14. A closure according to claim 13, wherein the second member is moved in a twisting motion relative to the first member.

15. A closure according to claim 1, wherein the base includes female threads.

16. A closure according to claim 15 in combination with a container, wherein the container has a neck with external threads adapted to cooperate with the threads on the base to attach the closure to the container.

17. A closure according to claim 1, wherein the one or more sections of porous vent material are disposed on the first member.

18. A closure according to claim 17, wherein the porous vent material is covered by the second member when the closure is in a closed position and exposed to air when the closure is in an open position.

19. A closure according to claim 1, wherein the first member and the base are unitary.

20. A closure according to claim 1, wherein the base comprises a containing wall generally perpendicular to and surrounding the first member.

21. A closure according to claim 20, wherein the one or more sections of porous vent material are disposed on the containing wall portion of the base.

22. A closure according to claim 20, wherein the base is adapted to couple with the top of an aluminum beverage can.

23. A closure for treating and dispensing a liquid, comprising:
a base adapted to secure the closure to a container;
a liquid path through the base through which liquid passes when the closure in use;
a porous treatment matrix contained within or connected to the liquid path, through which liquid passes when the closure is in use; and
a porous venting matrix secured to the base, wherein said porous venting matrix allows for passage of gases through the porous venting matrix and inhibits passage of liquid through the porous venting matrix thereby allowing for equalization of air pressure between a first location in contact with a first portion of said porous venting matrix and a second location in contact with a second portion of said porous venting matrix;
wherein said closure, when secured to a container during use, provides chemical treatment to a liquid as it passes said through said closure.

24. A closure according to claim 23, wherein the chemical treatment comprises adding a chemical to the liquid.

25. A closure according to claim 23, wherein the chemical treatment comprises selectively removing a preservative or other chemical from the liquid.

26. A closure according to claim 23, wherein the porous treatment matrix is directly connected to the liquid path.

27. A closure according to claim 23, wherein the porous treatment matrix is lies at least partially within the liquid path.

28. A closure according to claim 23, wherein the porous venting matrix surrounds the liquid path.

29. A closure according to claim 23, wherein the porous venting matrix comprises a hydrophobic material.

30. A closure according to claim 23, wherein the porous venting matrix comprises a plastic material having a high water intrusion pressure.

31. A closure according to claim 23, wherein the porous venting matrix provides sufficient venting to allow a substantially continuous liquid flux rate from the closure without creating a substantial pressure differential across the closure.

32. A closure according to claim 23, wherein the porous venting matrix provides sufficient venting to allow a substantially continuous liquid flux rate from the closure of at least about 50 ml/min/cm².

33. A closure according to claim 23, wherein the porous venting matrix provides sufficient venting to allow a substantially continuous liquid flux rate from the closure of at least about 500 ml/min/cm².

34. A closure according to claim 23, wherein the closure provides a pressure drop during dispensing of less than about 2 psi.

35. A closure according to claim 23, wherein the closure provides a pressure drop during dispensing of less than about 1 psi.

36. A closure for dispensing a liquid, comprising:
a base comprising means to secure the closure to a container;
a liquid path through the base through which liquid passes when the closure in use; and
a porous flow matrix having a high liquid flux rate and a low water intrusion pressure contained within or connected to the liquid path, through which liquid passes when the closure is in use;
wherein the porous flow matrix substantially prevents flow of liquid through the closure when the air pressure on opposing ends of the matrix are substantially equal.

37. A closure according to claim 36, further comprising a porous venting matrix secured to the base.

38. A closure according to claim 37, wherein the porous vent material provides sufficient venting to allow a substantially continuous liquid flux rate from the closure of at least about 50 ml/min/cm².

39. A closure according to claim 37, wherein the porous vent material provides sufficient venting to allow a substantially continuous liquid flux rate from the closure of at least about 500 ml/min/cm².

40. A closure according to claim 36, further comprising a tubular member that passes through the liquid path and connects the liquid path to the porous flow matrix.

41. A closure according to claim 36, wherein when in use the pressure drop is about 0.05 to 2.0 psi.

42. A beverage dispensing assembly, comprising:
a cap having an opening therein to allow flow of liquid and gas; and
a base housing adapted to be secured to a container; and
a generally hydrophobic porous vent material having a high water intrusion pressure contained within or connected to said base housing;
wherein the base housing and cap are movably coupled and cooperatively define a liquid path; and
wherein during use, vented air passing into the container follows a central axis around which the liquid flows as it passes out of the container and through the dispenser, thereby reducing air entrainment in the dispensed liquid.

43. A dispensing assembly according to claim 42, wherein the assembly provides a pressure drop during dispensing of less than about 2 psi.

44. A dispensing assembly according to claim 42, wherein the assembly provides a pressure drop during dispensing of less than about 1 psi.

45. A dispensing assembly according to claim 42, wherein the porous vent material provides sufficient venting to allow a substantially continuous liquid flux rate from the assembly without creating a substantial pressure differential across the assembly.

46. A dispensing assembly according to claim 42, wherein the porous vent material provides sufficient venting to allow a substantially continuous liquid flux rate from the assembly of at least about 50 ml/min/cm².

47. A dispensing assembly according to claim 42, wherein the porous vent material provides sufficient venting to allow a substantially continuous liquid flux rate from the assembly of at least about 500 ml/min/cm².

48. A dispensing assembly according to claim 42, further comprising a porous flow matrix within at least a portion of the liquid path, wherein the flow matrix is adapted to substantially inhibit flow of liquid through the flow matrix unless an air pressure differential exists between inside and outside a container to which the assembly is attached.

49. A dispensing assembly according to claim 42, wherein the air pressure differential is about 0.05 to 2.0 psi.

50. A dispensing assembly according to claim 41, wherein the fluid path is opened to allow fluid flow out of a container by moving the cap relative to the base.

51. A dispensing assembly according to claim 42, wherein the cap is moved in a twisting motion relative to the base.

52. A dispensing assembly according to claim 42, wherein the base includes female threads.

53. A assembly according to claim 52 in combination with a container, wherein the container has a neck with external threads adapted to cooperate with the threads on the base to attach the assembly to the container.
